(19) United States
(12) Patent Application Publication
(10) Pub. No.: US 2025/0131500 A1
(43) Pub. Date: Apr. 24, 2025

(54) SYSTEMS AND METHODS FOR SIMULATING ASSET DISTRIBUTION

(71) Applicant: Wells Fargo Bank, N.A., San Francisco, CA (US)

(72) Inventors: Mathew Degenhardt, San Francisco, CA (US); Jaclyn Olmos-Lym, San Francisco, CA (US); Tanisha Patterson-Powe, Huntersville, NC (US); Sarah Ward, San Francisco, CA (US)

(73) Assignee: Wells Fargo Bank, N.A., San Francisco, CA (US)

(21) Appl. No.: 18/381,283

(22) Filed: Oct. 18, 2023

(51) Int. Cl. G06Q 40/06; G06F 3/0482; G06F 3/04845

(52) U.S. Cl. CPC G06Q 40/06; G06F 3/0482; G06F 3/04845

(57) ABSTRACT

A system includes a processing circuit configured to receive asset data relating to assets and asset distribution parameters. The processing circuit is further configured to model the asset data with the asset distribution parameters to generate initial distribution data for the assets. The processing circuit is further configured to generate initial display data based on the initial distribution data and provide the initial display data to a user device. The processing circuit is further configured to receive a user adjustment to the elements from the user device. The processing circuit is further configured to model the initial distribution data with the user adjustment to generate adjusted distribution data. The processing circuit is further configured to generate adjusted display data based on the adjusted distribution data and provide the adjusted display data to the user device.

### TECHNICAL FIELD

The present disclosure relates generally to the field of estate planning, including simulating and displaying the asset distribution of an estate.

### BACKGROUND

People typically have difficulty visualizing adjustments to how their assets will be distributed to beneficiaries after the death of the person. For example, in some instances, changing how an asset will be distributed to a beneficiary may adjust how the asset will be distributed to other beneficiaries. Because adjustments to how assets will be distributed to beneficiaries may result in unintended results, people strive to understand all of the consequences of adjustments to how their assets will be distributed to beneficiaries.

### SUMMARY

Some arrangements relate to a system. In some arrangements, the system includes a processing circuit. In some arrangements, the processing circuit includes memory and one or more processors. In some arrangements, the processing circuit is configured to receive asset data relating to one or more assets of a person and asset distribution parameters. In some arrangements, the processing circuit is also configured to model the asset data with the asset distribution parameters to generate initial distribution data for the assets. In some arrangements, the initial distribution data corresponds to one or more initial associations between one or more beneficiaries and the one or more assets based on the asset distribution parameters. In some arrangements, the processing circuit is also configured to generate initial display data based on the initial distribution data and provide the initial display data to a user interface of a user device. In some arrangements, the initial display data includes a plurality of elements relating to the one or more associations between the one or more assets and the one or more beneficiaries. In some arrangements, the processing circuit is also configured to receive a user adjustment to at least one of the elements of the plurality of elements from the user device. In some arrangements, the processing circuit is also configured to model the initial distribution data with the user adjustment to generate adjusted distribution data by adjusting the one or more associations between the one or more beneficiaries and the one or more assets of the initial distribution data based on the user adjustment. In some arrangements, the processing circuit is also configured to generate adjusted display data based on the adjusted distribution data and provide the adjusted display data to the user interface.

Some arrangements relate to a method. In some arrangements, the method includes receiving, by a processing circuit, asset data relating to one or more assets of a person and asset distribution parameters. In some arrangements, the method also includes modeling the asset data with the asset distribution parameters to generate initial distribution data for the assets. In some arrangements, the initial distribution data corresponds to one or more initial associations between one or more beneficiaries and the one or more assets based on the asset distribution parameters. In some arrangements, the method also includes generating initial display data based on the initial distribution data and providing the initial display data to a user interface of a user device. In some arrangements, the initial display data includes a plurality of elements relating to the one or more associations between the one or more assets and the one or more beneficiaries. In some arrangements, the method also includes receiving a user adjustment to at least one of the elements of the plurality of elements from the user device. In some arrangements, the method also includes modeling the initial distribution data with the user adjustment to generate adjusted distribution data by adjusting the one or more associations between the one or more beneficiaries and the one or more assets of the initial distribution data based on the user adjustment. In some arrangements, the method also includes generating adjusted display data based on the adjusted distribution data and providing the adjusted display data to the user interface.

Some arrangements relate to a computer-readable storage medium (CRM) having instructions stored thereon that, when executed by a processing circuit, cause the processing circuit to perform operations. The operations include receiving, by the processing circuit, asset data relating to one or more assets of a person and asset distribution parameters. In some arrangements, the operations include modeling the asset data with the asset distribution parameters to generate initial distribution data for the assets. In some arrangements, the initial distribution data corresponds to one or more initial associations between one or more beneficiaries and the one or more assets based on the asset distribution parameters. In some arrangements, the operations include generating initial display data based on the initial distribution data and provide the initial display data to a user interface of a user device. In some arrangements, the initial display data includes a plurality of elements relating to the one or more associations between the one or more assets and the one or more beneficiaries. In some arrangements, the operations include receiving a user adjustment to at least one of the elements of the plurality of elements from the user device. In some arrangements, the operations include modeling the initial distribution data with the user adjustment to generate adjusted distribution data by adjusting the one or more associations between the one or more beneficiaries and the one or more assets of the initial distribution data based on the user adjustment. In some arrangements, the operations include generating adjusted display data based on the adjusted distribution data and providing the adjusted display data to the user interface.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of an asset simulation architecture including an asset simulation system, according to example embodiments.

FIG. 2 is a block diagram illustrating an example computing system suitable for use in the example embodiments described herein.

FIG. 3 is a depiction of an example of modeling of asset data with asset distribution parameters to generate initial distribution data for assets, according to example embodiments.

FIG. 4 is a depiction of an example of modeling of initial distribution data with a user adjustment to generate adjusted distribution data, according to example embodiments.

FIG. 5 is a flow diagram of a method for simulating asset distribution, according to example embodiments.

FIG. 6A is an illustration of a configuration of a user interface generated by the asset simulation system of FIG. 1, according to example embodiments.

FIG. 6B is an illustration of an additional configuration of a user interface generated by the asset simulation system of FIG. 1, according to example embodiments.

FIG. 6C is an illustration of an additional configuration of a user interface generated by the asset simulation system of FIG. 1, according to example embodiments.

FIG. 6D is an illustration of an additional configuration of a user interface generated by the asset simulation system of FIG. 1, according to example embodiments.

FIG. 6E is an illustration of an additional configuration of a user interface generated by the asset simulation system of FIG. 1, according to example embodiments.

FIG. 6F is an illustration of an additional configuration of a user interface generated by the asset simulation system of FIG. 1, according to example embodiments.

FIG. 6G is an illustration of an additional configuration of a user interface generated by the asset simulation system of FIG. 1, according to example embodiments.

FIG. 6H is an illustration of an additional configuration of a user interface generated by the asset simulation system of FIG. 1, according to example embodiments.

### DETAILED DESCRIPTION

Referring generally to the figures, the systems and methods described herein relate to simulating asset distribution. In some arrangements, a person may desire to simulate the distribution of the assets owned by the person to determine what will happen to the assets after the person is deceased. The distribution of the assets may be governed by asset distribution parameters, such as account specific documents, wills, intestacy laws, or other means of controlling the disposition of the assets. To simulate the distribution of the assets, the asset distribution parameters may be modeled with asset data associated with the assets to determine beneficiaries that will be associated with the assets after the person is deceased. These associations between the assets and the beneficiaries may be combined into initial distribution data and then provide an interface of the initial distribution data to the person. Through this process, the systems and methods enable the person to visualize what will happen to the assets owned by the person after the person is deceased. Furthermore, the person may then adjust the associations between the assets and the beneficiaries in the interface to visualize how the adjustments to the associations will affect what will happen to the assets owned by the person after the person is deceased.

In typical systems and methods, a computer device (e.g., desktop computer, mobile device, smart device) can determine how assets will be distributed to beneficiaries after a person is deceased and provide the person with a visualization of how the assets will be distributed. However, given that the person may not be able to adjust the visualization of associations between the assets and the beneficiaries in the typical systems and methods to visualize how adjustments to the associations will affect how the assets will be distributed, the typical systems and methods may not allow for the person to determine what adjustments should be made to the associations between the assets and the beneficiaries to distribute the assets in a manner preferred by the person. The systems and methods described herein address this issue, providing the person with display data of the associations between the assets and the beneficiaries that may be adjusted by the person, such that the person may determine and visualize an adjusted distribution of the assets to the beneficiaries that is preferred by the person.

In some arrangements, the systems and methods are configured to generate display data that includes elements that relate to the associations between the assets and the beneficiaries. A user may then adjust the elements to update the display data to visualize the adjusted distribution of the assets to the beneficiaries. This is accomplished by modeling user adjustments to the elements with the initial distribution data to generate adjusted distribution data that includes adjustments to the associations between the assets and the beneficiaries that correspond to the adjustment of the elements by the user. The adjusted distribution data can then be displayed to the user for the user to visualize the adjustments to the associations between the assets and the beneficiaries. In some arrangements, the elements may include arrows illustrating the associations between the assets and the beneficiaries and the user adjustments may be dragging and dropping arrows between the assets and the beneficiaries or changing a size of the arrows between the assets and the beneficiaries. In some arrangements, changing the size of one of the arrows between the assets and the beneficiaries causes a change of the size of a remainder of the arrows between the assets and the beneficiaries to the account. The elements may also include a selectable condition associated with one of the beneficiaries. Therefore, the systems and methods provide an improvement to existing systems and methods by providing users with a display of the distribution of the assets to the beneficiaries that is adjustable, such that the users may visualize and adjust the distribution. Furthermore, the adjustments including dragging and dropping arrows, changing the size of arrows, and selecting conditions may simplify the process of making adjustments to the display data of the initial distribution data by providing a user friendly mechanism for making the adjustments. This can reduce the number of steps that a person needs to take to make adjustments to the display data of the initial data, resulting in a reduction in processing power, bandwidth across servers, etc. that is needed to support making adjustments to the display data of the initial distribution data.

In some arrangements, the systems and methods are configured to generate suggestions that would bring the initial distribution data in line with the adjusted distribution data. This is accomplished by identifying variations between the initial distribution data and adjusted distribution data generated based on the user adjustments and then modeling the variations with the asset distribution parameters to determine changes to the asset distribution parameters that would reduce the variations. These changes to the asset distribution parameters may be presented as suggestions to modify portions of the asset distribution parameters, such as modifying a will or an account specific document. In some arrangements, the systems and methods are configured to modify the asset distribution parameters based on the suggestions, either automatically or after receiving an input from a user. Thus, the systems and methods are configured to determine changes to the asset distribution parameters that would cause the associations between the assets and the beneficiaries to match the adjusted distribution data that was generated based on the user adjustments to the initial data. The suggestion of these changes may notify the person of the changes to the asset distribution parameters that would result in the asset distribution that is preferred by the person that may otherwise be impossible to determine and present back to the person by a human without the use of the inventive concepts described herein.

Additionally, the present disclosure is directed to systems and methods that takes into account the distribution of gifts to beneficiaries by modeling gift data associated with the gifts previously given by the person with gift distribution parameters. This approach combines the association between the gifts and the beneficiaries with the association between of the assets and the beneficiaries to present a more complete visualization of what has been received by the beneficiaries and what will be received by the beneficiaries after the person is deceased. This more complete visualization may allow for the person to determine adjustments to asset distribution parameters that will result in a “fairer” distribution of the gifts and the assets that may result in each of the beneficiaries receiving an equal combined value of the gifts and the assets.

Accordingly, the present disclosure is directed to systems and methods that improve the simulation and visualization of how assets will be distributed after a person is deceased, while also allowing for adjustments to the visualization of the asset distribution and providing suggestions to bring the simulation of the asset distribution in line with the adjustments to the visualization of the asset distribution. It achieves this by implementing models for simulating asset distribution, models for adjusting asset distribution visualizations based on user adjustments, models for determining variations between asset distributions and adjusted asset distribution visualizations, and models for determining suggestions that minimize the variations between the asset distributions and the adjusted asset distribution visualizations. This approach allows for users to visualize simulated associations between assets and beneficiaries while allowing for the users to make adjustments to the visualization of the simulated associations to form adjusted associations. Furthermore, the approach also identifies differences and provides suggestions for limiting the differences between the simulated associations and the adjusted associations.

As used herein, “asset” refers to a resource that a person may own or control and that may be passed on to a beneficiary after the death of the person. That is, an asset may be inherited or received by a beneficiary following the end of the life of the person. In some embodiments, an asset could refer to real estate, vehicles, furniture, artwork, jewelry, cash, or other tangible items or intangible items such as intellectual property. In some embodiments an asset could refer to a savings account, a retirement account, life insurance, or other intangible items. After the person is deceased, assets may be passed on to beneficiaries that inherit the assets or a portion thereof.

As used herein, “gift” refers to a resource that a person may own or control and that may have been given or is planned to be given to a beneficiary prior to the death of the person. That is, a gift may be given voluntarily to a beneficiary by the person prior to the end of the life of the person without the expectation of receiving something in return. In some embodiments, a gift could be real estate, vehicles, furniture, artwork, jewelry, cash, or other tangible items or intangible items such as intellectual property. In some embodiments a gift could refer to a tuition payment, an investment account, supporting the starting of a business, or other items or information.

As used herein, “asset distribution parameter” refers to the guidelines, rules, or criteria set in place to govern how assets of a person are divided and allocated among beneficiaries. That is, an asset distribution parameter outlines the specific conditions, proportions, or methods by which different assets will be distributed after the death of the person. In some embodiments, the asset distribution parameters could include elements from at least one of a will of the person, a trust created by the person to manage the assets of the person, account specific documents, beneficiary laws, intestacy laws, or other means of controlling how different assets will be distributed following the death of the person. The asset distribution parameters may include elements from multiple sources to determine how each of the assets will be distributed after the death of the person. In some embodiments, the asset distribution parameters may take into account that one source of parameters takes priority over a second source of parameters. For example, a will may specify that a first beneficiary receives a retirement account, but an account specific document specifying that a second beneficiary receives the retirement account would take precedence over the will. As a result, the asset distribution parameters would include a parameter that that the retirement account is associated with the second beneficiary due to the account specific document taking priority over the will with regards to the retirement account. In some embodiments, a person may not have a will or other documentation and the asset distribution parameters may rely on intestacy laws. In some embodiments, a person may not have an identified beneficiary and the asset distribution parameters may determine that any of the assets of the person will be allocated to a state or federal government upon the death of the person.

As used herein, “beneficiary” refers to an individual or an entity who is designated to receive assets of a person after the death of the person. That is, a beneficiary is an individual or an entity that has a legal entitlement to the assets of a person who is deceased. The beneficiaries of the assets may be identified in a will, an account specific document, beneficiary laws, intestacy laws, or other means of controlling how different assets will be distributed following the death of the person. In some embodiments, a beneficiary can include an individual or entity who has received a gift from the person prior to the death of the person or who the person is planning on giving a gift to prior to the death of the person. In some embodiments, a beneficiary can include a family member of the person, a friend of the person, an organization, a charity, or any parties indicated by the asset distribution parameters. In some embodiments, a state or federal government may be the beneficiary if no other beneficiaries are indicated.

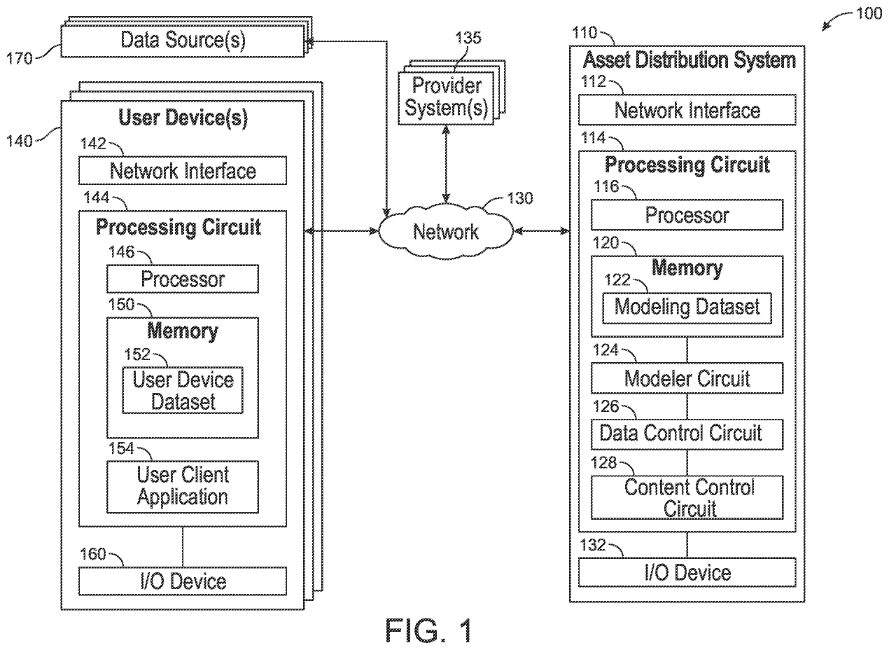

Referring to FIG. 1, a block diagram of a distribution modeler architecture 100 including an asset distribution system 110 is shown, according to some embodiments. The asset distribution system 110 can be associated with a provider, such as a service provider, medical office, law office, bank, or financial institution (FI). The distribution modeler architecture 100 further includes one or more user devices (e.g., user device 140), one or more data sources (e.g., data source 170), and an asset distribution system 110 (e.g., a computing system of the FI). In some embodiments, the asset distribution system 110, one or more user devices 140, and data source 170 are communicatively coupled. In some embodiments, the components of the distribution modeler architecture 100 may be communicably and operatively coupled to each other over a network, such as network 130, that permits the direct or indirect exchange of data, values, instructions, messages, and the like (represented by the double-headed arrows in FIG. 1). The network 130 may include one or more of a cellular network, the Internet, Wi-Fi™, Wi-Max™, a proprietary provider network, a proprietary retail or service provider network, and/or any other kind of wireless or wired network.

Each system or device in distribution modeler architecture 100 may include one or more processors, memories, and network interfaces (sometimes referred to herein as a “network circuit”). The memory may store programming logic that, when executed by the processor, controls the operation of the corresponding computing system or device. The memory may also store data in databases. For example, memory 120 may store programming logic that when executed by processor 116 within processing circuit 114, causes an update in the modeling dataset 122 from a user's account with information received from a user device 140 and/or data sources 170. The various components of devices in distribution modeler architecture 100 may be implemented via hardware (e.g., circuitry), software (e.g., executable code), or any combination thereof. Devices and components in FIG. 1 can be added, deleted, integrated, separated, and/or rearranged in various embodiments of the disclosure.

The asset distribution system 110 may be operated by a provider. The asset distribution system 110 includes a network interface 112 and can be structured and used to establish connections with other computing systems and devices (e.g., the user devices 140, the data source 170, etc.) via the network 130. The network interface 112 includes program logic that facilitates connection of the asset distribution system 110 to the network 130. For example, the network interface 112 may include any combination of a wireless network transceiver (e.g., a cellular modem, a Bluetooth™ transceiver, a WiFi™ transceiver, etc.) and/or a wired network transceiver (e.g., an Ethernet transceiver). In some arrangements, the network interface 112 includes the hardware (e.g., processor, memory, and so on) and machine-readable media sufficient to support communication over multiple channels of data communication. Further, in some arrangements, the network interface 112 includes cryptography capabilities to establish a secure or relatively secure communication session in which data communicated over the session is encrypted. In various embodiments, the distribution modeler architecture 100 can adapt to network traffic needs by compressing content, by any computing device described herein, and sending it (e.g., via network 130) to various other computing devices, by adjusting security filters to remove junk traffic off network 130 (e.g., by monitoring packets), and so on.

The processing circuit 114 includes a processor 116, a memory 120, a modeler circuit 124, a data control circuit 126, and a content control circuit 128. In other embodiments, the processing circuit 114 may contain more or less components than are shown in FIG. 1. The components of FIG. 1 are meant for illustrative purposes only and should not be regarded as limiting in any manner. The memory 120 may be one or more devices (e.g., RAM, ROM, Flash memory, hard disk storage) for storing data and/or computer code for completing and/or facilitating the various processes described herein. The memory 120 may be or include non-transient volatile memory, non-volatile memory, and non-transitory computer storage media. Memory 120 may include database components, object code components, script components, or any other type of information structure for supporting the various activities and information structures described herein. Memory 120 may be communicably coupled to the processor 116 and include computer code or instructions for executing one or more processes described herein. The processor 116 may be implemented as one or more application specific integrated circuits (ASICs), field programmable gate arrays (FPGAs), a group of processing components, or other suitable electronic processing components. As such, the asset distribution system 110 is configured to run a variety of application programs and store associated data in a database of the memory 120 (e.g., modeling dataset 122). One such application may be to provide data to the modeler circuit 124, data control circuit 126, and content control circuit 128.

The processing circuit 114, interacting (e.g., communicating with by sending requests and/or commands/signals) with the memory 120 can store a variety of data in the modeling dataset 122, according to some embodiments, including asset data structures. The modeler circuit 124 can use data stored in the modeling dataset 122 and other gathered data to generate an asset data structure which could then be stored in the modeling dataset 122. The modeling dataset 122 may also be configured to store the asset data structure which can include assets of a person associated with one or more beneficiaries. For example, the modeling dataset 122 can store asset information of assets of the person, such as real estate, financial accounts, and other assets. The modeling dataset can store other information used in modeling activity such as asset distribution parameters that dictate how the assets will be distributed upon the death of the person. In some embodiments, the modeling dataset 122 can include a token vault that stores an associated asset token and/or distribution token for each beneficiary. The modeling dataset 122 may further be configured to store beneficiary data for each beneficiary, such as conditions associated with each beneficiary, contact information associated with each beneficiary, and so on.

In some embodiments, the memory 120 and modeling dataset 122 may be communicably coupled to the modeler circuit 124, data control circuit 126, or content control circuit 128. It should be understood that “circuit” used herein can be any processing circuit(s) or computational systems designed to perform specific tasks, including but not limited to microprocessors, microcontrollers, application-specific integrated circuits (ASICs), field-programmable gate arrays (FPGAs), or any combination thereof, capable of executing the required functions and operations for handling, analyzing, and processing the asset data, asset distribution parameters, actionable activities, and other inputs as described herein. The modeler circuit 124 can implement modeling operations of the asset distribution system 110. In various arrangements, the modeler circuit 124 can be configured to receive a plurality of data from a plurality of data sources (e.g., memory 120, modeling dataset 122, data control circuit 126, content control circuit 128, user device 140, data source 170) via one or more data channels (e.g., over network 130). Each data channel may include a network connection (e.g., wired, wireless, cloud) between the devices or systems and the asset distribution system 110. For example, the modeler circuit 124 could query the memory 120 for data of the modeling dataset 122 and use the modeling data to generate asset distribution parameters that models asset data to generate initial distribution data (e.g., the modeling dataset that includes parameters that associate certain of the assets with certain of the beneficiaries).

The modeler circuit 124 can be configured to receive asset data relating to a plurality of assets of a person and asset distribution parameters from a user device 140, a data source 170, or a provider system 135 via the network 130. The asset data may include names of the assets, valuations of the assets, photographs of the assets, or other information relating to the assets. In some embodiments, the user device 140 may provide the asset data and the asset distribution parameters after receiving an input to a user interface of the user device. For example, a user may request that an analysis of asset distribution be performed through the user interface of the user device 140 and may also upload asset data relating to the assets and asset distribution parameters relating to the assets and to beneficiaries to the user device 140. The asset distribution parameters uploaded by the user may include all of the asset distribution parameters or the modeler circuit 124 may need to receive additional asset data and/or additional asset distribution parameters from a different source (e.g., the provider system 135, the data source 170, etc.).

The modeler circuit 124 can be further configured to model the asset data with the asset distribution parameters to generate initial distribution data for the assets. In some embodiments, the initial distribution data corresponds to one or more initial associations between one or more beneficiaries and one or more of the assets based on the asset distribution parameters. The initial associations can indicate which of the assets will be passed on to which of the beneficiaries after the death of the person. For example, the asset data may include a first asset and the asset distribution parameters may include a parameter that directs that the first asset should be passed on to a first beneficiary. The modeler circuit 124 can model the asset data with the asset distribution parameters to generate initial distribution data that include the initial association between the first asset and the first beneficiary. For example, a person may own a property and the person may have a will that indicates that the property should be passed on to a spouse of the person. The modeler circuit 124 can model property data relating to the property with asset distribution parameters that include the specifications of the will to generate initial distribution data that corresponds to an association between the property and the spouse.

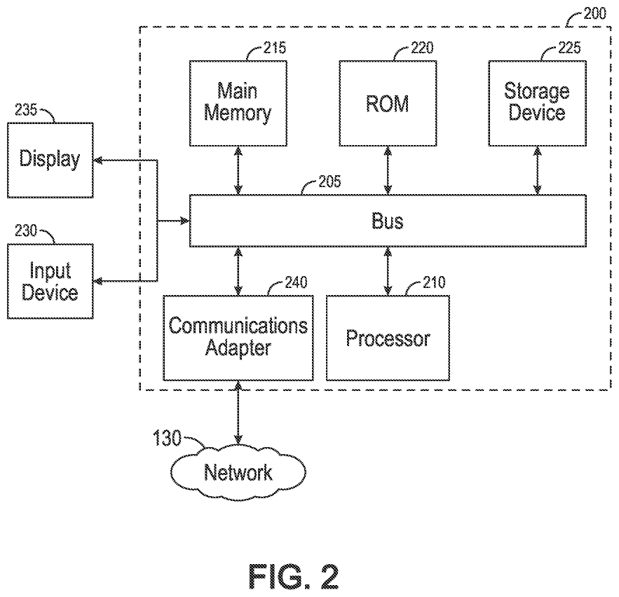

Referring now to FIG. 2, a depiction of a computing system 200 is shown. The computing system 200 that can be used, for example, to implement a distribution modeler architecture 100, asset distribution system 110, provider systems 135, user devices 140, data sources 170, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210.

The computing system 200 may further include a read only memory (ROM) 220 or other static storage device coupled to the bus 205 for storing static information and instructions for the processor 210. A storage device 225, such as a solid-state device, magnetic disk or optical disk, is coupled to the bus 205 for persistently storing information and instructions.

The computing system 200 may be coupled via the bus 205 to a display 235, such as a liquid crystal display, or active matrix display, for displaying information to a user. An input device 230, such as a keyboard including alphanumeric and other keys, may be coupled to the bus 205 for communicating information, and command selections to the processor 210. In another arrangement, the input device 230 has a touch screen display 235. The input device 230 can include any type of biometric sensor, a cursor control, such as a mouse, a trackball, or cursor direction keys, for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to enable communications with a computing or communications network 130 and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate illustrative arrangements that are described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the example processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

That is, although an example processing system has been described in FIG. 2, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 200 may include virtualized systems and/or system resources. For example, in some arrangements, the computing system 200 may be a virtual switch, virtual router, virtual host, or virtual server. In various arrangements, computing system 200 may share physical storage, hardware, and other resources with other virtual machines. In some arrangements, virtual resources of the network 130 (e.g., network 130 of FIG. 1) may include cloud computing resources such that a virtual resource may rely on distributed processing across more than one physical processor, distributed memory, etc.

As used herein, the term “resource” refers to a physical or virtualized (for example, in cloud computing environments) computing resource needed to execute computer-based operations. Examples of computing resources include computing equipment or device (server, router, switch, etc.), storage, memory, executable (application, service, and the like), data file or data set (whether permanently stored or cached), and/or a combination thereof (for example, a set of computer-executable instructions stored in memory and executed by a processor, computer-readable media having data stored thereon, etc.).

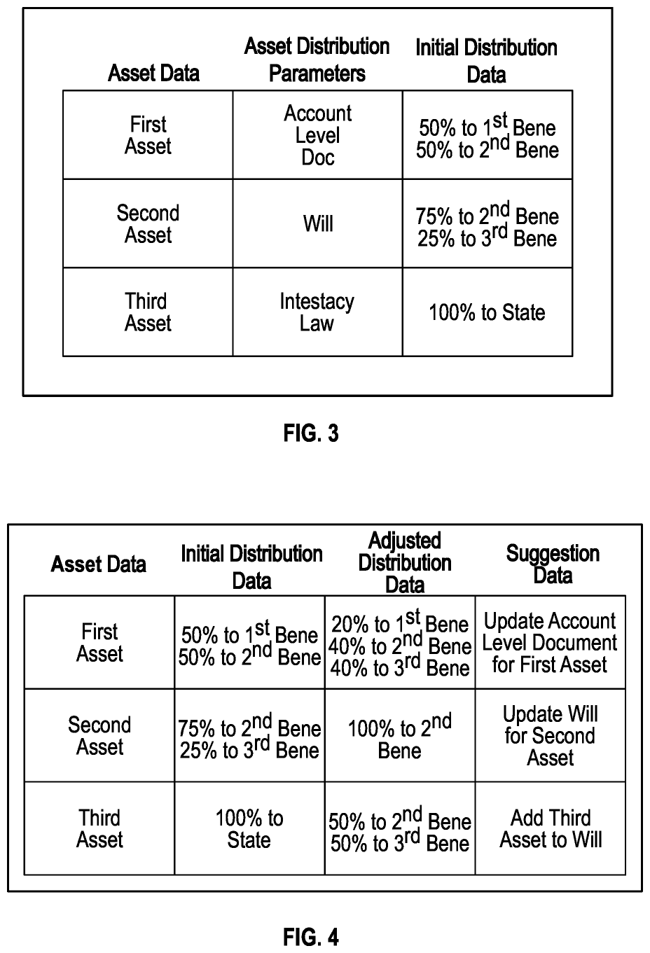

Referring to FIG. 3, an example of the modeling of the asset data with the asset distribution parameters to generate initial distribution data for the assets is shown. The asset data in the example shown in FIG. 3 includes a first asset, a second asset, and a third asset. The asset distribution parameters in the example shown in FIG. 3 include an account level document (e.g., a beneficiary set for an account, etc.), a will, and an intestacy law. The modeler circuit 124 is shown to model the first asset with the account level document to generate initial distribution data that associates 50% of the first asset with a first beneficiary and 50% of the first asset with a second beneficiary. The modeler circuit 124 is also shown to model the second asset with the will to generate initial distribution data that associates 75% of the second asset with the second beneficiary and 25% of the second asset with a third beneficiary. The modeler circuit 124 is also shown to model the third asset with the intestacy law to generate initial distribution data that associates 100% of the third asset with a state government.

Referring back to FIG. 1, the modeler circuit 124 can be further configured to receive new or updated asset data and/or asset distribution parameters from the input/output device 132 of the asset distribution system 110 or from the modeling dataset 122. For example, the modeler circuit 124 may be configured to continuously monitor and receive new information from the user device 140, the data source 170, or the provider system 135 via the network 130 and determine the effect on the initial distribution data. New data can affect the modeling dataset 122 and thereon after the modeler circuit 124, data control circuit 126, content control circuit 128, and other parts of the asset distribution system 110. For example, a rule guiding asset distribution could be updated after the asset distribution system 110 has already modeled the asset data with the asset distribution parameters. A source (e.g., user device 140, data source 170, or provider system 135) may then send the update of the rule guiding asset distribution (e.g., change to intestacy law) to the asset distribution system 110. Because asset distribution parameter updates can be a significant factor affecting the distribution of the assets, not only would the modeling dataset 122 be updated with the update to the asset distribution parameter, but the modeler circuit 124 would update the initial distribution data. For example, the update to the asset distribution parameter could cause the modeler circuit 124 to change the assets associated with a beneficiary, which affects the distribution of the assets of the person.

The modeler circuit 124 can be further configured to identify when new or updated asset data and/or asset distribution parameters cause the modeler circuit 124 to update the initial distribution data. For example, if the new or updated asset data and/or asset distribution data result in a shift in the initial distribution data, the modeler circuit 124 may identify that the shift in the initial distribution data has occurred. For example, if the asset distribution parameters are updated to remove a deceased beneficiary and the initial distribution data is updated to remove the associations between the deceased beneficiary and any of the assets associated with the deceased beneficiary, the modeler circuit 124 may identify that the assets are no longer associated with the deceased beneficiary. As another example, if the asset data is updated to remove a destroyed asset and the initial distribution data is updated to remove the associations between the destroyed asset and any of the beneficiaries associated with the destroyed asset, the modeler circuit 124 may identify that the beneficiaries are no longer associated with the destroyed asset.

The modeler circuit 124 can be further configured to receive a user adjustment corresponding to the initial distribution data from the input/output device 132 of the asset distribution system 110. For example, the modeler circuit 124 may be configured to receive the user adjustment from the user device 140, the data source 170, or the provider system 135 via the network 130. In some embodiments, the user adjustment may be processed by the content control circuit 128 before being received by the modeler circuit 124. For example, the user adjustment may correspond to an interactive interface generated by the content control circuit 128 discussed in more detail below.

The modeler circuit 124 can be further configured to model the initial distribution data with the user adjustment to generate adjusted distribution data by adjusting the associations between the beneficiaries and the assets of the initial distribution data based on the user adjustments. In some embodiments, the user adjustment may correspond to changing a ratio of one of the assets associated with one of the beneficiaries, the user adjustment may correspond to adding a new association between one of the assets and one of the beneficiaries, or the user adjustment may correspond to selecting a condition associated with one of the beneficiaries. For example, the user adjustment may be to increase a ratio of one of the assets that is associated with one of the beneficiaries. The modeler circuit 124 can then model the initial distribution data with the user adjustment to generate the adjusted distribution data that includes increasing the ratio of the one of the assets associated with the one of the beneficiaries, while also adjusting the ratio of the one of the assets associated with a remainder of the beneficiaries such that an entirety of the asset is still associated with the beneficiaries. For example, the user adjustment may be to increase a portion of a 401k retirement account associated with an older child to 50%. The modeler circuit 124 can then model the initial distribution data that associates 30% of the 401k retirement account with the older child and 70% of the 401k retirement account with a younger child with the user adjustment to generate the adjusted distribution data that associates 50% of the 401k retirement account with the older child and 50% of the 401k retirement account with the younger child. As another example, the initial distribution data may associate one of the assets with a first beneficiary. The user adjustment may be to change the association of the one of the assets from the first beneficiary to a second beneficiary. The modeler circuit 124 can then model the initial distribution data with the user adjustment to generate the adjusted distribution data that includes the association of the one of the assets with the second beneficiary and removes the association of the one of the assets with the first beneficiary.

As another example, the user adjustment may correspond to selecting a condition associated with one of the beneficiaries. In some embodiments, the condition could be a death of the one of the beneficiaries, a disinheritance of the one of the beneficiaries, or another condition affecting the distribution of assets to the one of the beneficiaries. The modeler circuit 124 can then model the initial distribution data with the user adjustment of the selection of the condition to generate the adjusted distribution data that removes the association of any of the assets with the one of the beneficiaries. In some embodiments, the adjusted distribution data may associate the assets that were removed from the one of the beneficiaries to the remainder of the beneficiaries based on the asset distribution parameters.

In some embodiments, the modeler circuit 124 can be configured to identify one or more variations between the initial distribution data and the adjusted distribution data. For example, the modeler circuit 124 may identify that the association of one of the assets has been adjusted from a first beneficiary to a second beneficiary. As another example, the modeler circuit 124 may identify that a first portion of one of the assets associated with a first beneficiary has increased and that a second portion of the one of the assets associated with a second beneficiary has decreased. As yet another example, the modeler circuit 124 may identify that the association between the assets associated with one of the beneficiaries have been removed due to the selection of a condition associated with the one of the beneficiaries and that the assets that were associated with the one of the beneficiaries are now associated with a remainder of the beneficiaries.

In some embodiments, the modeler circuit 124 can be further configured to model the one or more variations between the initial distribution data and the adjusted distribution with the asset distribution parameters to generate suggestion data. In some embodiments, the suggestion data correspond to one or more changes to the asset distribution parameters that would reduce the variations between the initial distribution data and the adjusted distribution data. For example, if the variation is that the association of one of the assets has been adjusted from a first beneficiary to a second beneficiary, the modeler circuit 124 may model the variation to generate a suggestion that an account document associated with the one of the assets be modified to specify the second beneficiary instead of the first beneficiary. As another example, if the variation is that a first portion of one of the assets associated with a first beneficiary has increased and that a second portion of the one of the assets associated with a second beneficiary has decreased, the modeler circuit 124 may model the variation to generate a suggestion that a will be modified to specify that the first portion of the one of the assets should be passed on to the first beneficiary and the at the second portion of the one of the assets should be passed on to the second beneficiary. As yet another example, if the variation is that the association between the assets associated with one of the beneficiaries have been removed due to the selection of a condition associated with the one of the beneficiaries and that the assets that were associated with the one of the beneficiaries are now associated with a remainder of the beneficiaries, the modeler circuit 124 may model the variation to generate a suggestion that a will be revised to include the condition associated with the one of the beneficiaries, where if the condition is triggered than the one of the beneficiaries will not receive any of the assets and any assets associated with the one of the beneficiaries will be redistributed with the remainder of the beneficiaries.

Referring to FIG. 4, an example of the modeling of the initial distribution data with the user adjustment to generate adjusted distribution data by adjusting the associations between the beneficiaries and the assets of the initial distribution data based on the user adjustment is shown. The asset data in the example shown in FIG. 4 includes a first asset, a second asset, and a third asset. The initial distribution data in the example shown in FIG. 4 includes the associations of 50% of the first asset with a first beneficiary, 50% of the first asset with a second beneficiary, 75% of the second asset with the second beneficiary, 25% of the second asset with a third beneficiary, and 100% of the third asset with a state government. The modeler circuit 124 then receives a first user adjustment that includes adding an association between the first asset and the third beneficiary and increasing a size of the association between the first asset and the second beneficiary and the first asset and the third beneficiary. The modeler circuit 124 is shown to model the initial distribution data with the first user adjustment to generate adjusted distribution data that associates 20% of the first asset with the first beneficiary, 40% of the first asset with the second beneficiary, and 40% of the first asset with the third beneficiary. The modeler circuit 124 also receives a second user adjustment that includes increasing a size of the association between the second asset and the second beneficiary. The modeler circuit 124 is shown to model the initial distribution data with the second user adjustment to generate adjusted distribution data that associates 100% of the second asset with the second beneficiary. The modeler circuit 124 also receives a third user adjustment that includes adding an association between the third asset and the second beneficiary and adding an association between the third asset and the third beneficiary. The modeler circuit 124 is shown to model the initial distribution data with the third user adjustment to generate adjusted distribution data that associates 50% of the third asset with the second beneficiary and 50% of the third asset with the third beneficiary.

Still referring to FIG. 4, an example of identifying and modeling of variations between the initial distribution data and the adjusted distribution data with the asset distribution parameters to generate suggestion data is shown. After modeling of the initial distribution data with the user adjustment to generate adjusted distribution data, the modeler circuit 124 may identify variations between the initial distribution data and the adjusted distribution data. In the example shown in FIG. 4, the modeler circuit 124 may identify a first variation between the adjusted distribution data and the initial distribution data for the first asset that includes the addition of an association between the first asset and the third beneficiary, a decrease in the size of the association between the first asset and the first beneficiary, and a decrease in the size of the association between the first asset and the second beneficiary. The modeler circuit 124 is then shown to model the first variation with the asset distribution parameters to generate first suggestion data that includes a suggestion to update an account level document for the first asset to achieve the associations between the first asset and the beneficiaries included in the adjusted distribution data. The modeler circuit 124 may also identify a second variation between the adjusted distribution data and the initial distribution data for the second asset that includes an increase in the size of the association between the second asset and the second beneficiary and a decrease in the size of the association between the second asset and the third beneficiary. The modeler circuit 124 is then shown to model the second variation with the asset distribution parameters to generate second suggestion data that includes a suggestion to update a will for the second asset to achieve the associations between the second asset and the beneficiaries included in the adjusted distribution data. The modeler circuit 124 may also identify a third variation between the adjusted distribution data and the initial distribution data for the third asset that includes the addition of an association between the third asset and the second beneficiary, the addition of an association between the third asset and the third beneficiary, and a decrease in the size of the association between the third asset and the state government. The modeler circuit 124 is then shown to model the third variation with the asset distribution parameters to generate third suggestion data that includes a suggestion to add the third asset to a will to achieve the associations between the third asset and the beneficiaries included in the adjusted distribution data.

In some embodiments, the modeler circuit 124 can be further configured to model the initial distribution data with the asset data to generate asset balance data. In some embodiments, the asset balance data corresponds to one or more changes to the asset distribution parameters that would result in each of the beneficiaries receiving an equal value of the assets. In some embodiments, the value of the assets can correspond to a monetary value of the assets, an emotional value of the assets, or a combination of the monetary value and the emotional value of the assets. For example, if the initial distribution data includes a first beneficiary associated with a first asset valued at $1,000 and that a second asset valued at $500 and a second beneficiary is associated with a third asset valued at $500 based on asset distribution parameters from a will, the modeler circuit 124 can model the initial distribution data with the asset data that includes the value of each of the assets to generate a balance option that the will be modified to specify that the first asset be associated with the first beneficiary and that the second asset and the third asset be associated with the second beneficiary such that the value of the assets associated with each of the beneficiaries are equal.

In some embodiments, the modeler circuit 124 can be configured to identify missing beneficiaries. For example, if the modeler circuit 124 receives data from the provider system 135, the user device 140 and/or the data source 170 that indicates that a potential beneficiary is not included as one of the beneficiaries in the initial distribution data generated by the modeler circuit 124, the modeler circuit 124 may identify the potential beneficiary. For example, if the modeler circuit 124 receives data from the user device 140 that the person has a child that is not included as one of the beneficiaries in the initial distribution data, the modeler circuit 124 may identify the child. In some embodiments, the identification of a missing beneficiary may result in an alert being generated and provided to the user device (e.g., by the content control circuit 128) that includes a notification that the missing beneficiary is not included as one of the beneficiaries in the initial distribution data.

In some embodiments, the modeler circuit 124 can be configured to receive gift data relating to a plurality of gifts of the person and gift distribution parameters. In some embodiments, the gifts may have been previously gifted by the person to the beneficiaries. In various embodiments, the gifts may include gifts that are planned to be given to the beneficiaries in the future. For example, the modeler circuit 124 may be configured to receive the gift data and the gift distribution parameters from a user device 140, a data source 170, or a provider system 135 via the network 130. The gift data may include names of the gifts, valuations of the gifts, photographs of the gifts, or other information relating to the gifts. In some embodiments, the user device 140 may provide the gift data and the gift distribution parameters after receiving an input to a user interface of the user device 140. For example, a person may request that a gift distribution analysis be performed through the user interface of the user device 140 and may also upload gift data relating to the gifts and information related to the gift distribution parameters to the user device 140. The information related to the gift distribution parameters may include all of the information necessary to generate the gift distribution parameters or the modeler circuit 124 may need to receive additional information related to the gift distribution parameters from a different source (e.g., the provider system 135, the data source 170, etc.).

In some embodiments, the gift data may include the gifts that are planned to be given to the beneficiaries in the future and the gift distribution parameters may include information relating the gifts that are planned to be given in the future to the beneficiaries that are planned to receive the gifts. For example, a person may plan on giving a tuition payment to a child prior to the death of the person. The person may upload gift data relating to the tuition payment and gift distribution parameters relating to the child to the user device 140.

In some embodiments, the modeler circuit 124 can be further configured to model the gift data with the gift distribution parameters to generate gift distribution data. In some embodiments, the gift distribution data corresponds to one or more associations between one or more beneficiaries and the gifts based on the gift distribution parameters. The associations can be that the gifts have already been given to the beneficiaries. In some embodiments, the associations can be that the person is planning on giving the gifts to the beneficiaries prior to the death of the person. For example, the gift data may include a first gift and the gift distribution parameters may include a parameter that indicates that the first gift has been given to a first beneficiary. The modeler circuit can then model the gift data with the gift distribution parameters to generate gift distribution data that include the association between the first gift and the first beneficiary. For example, a person may have owned a piece of jewelry that the person gifted to a friend. The modeler circuit can model the gift data related to the piece of jewelry with gift distribution parameters that include that the piece of jewelry was gifted to a friend to generate gift distribution data that includes an association between the piece of jewelry and the friend. In some embodiments, after generating the gift distribution data the modeler circuit 124 can be further configured to update the initial distribution data to include the gift distribution data.

In some embodiments, the modeler circuit 124 can be further configured to model the gift distribution data with the gift data and the asset distribution data with the asset data to generate comprehensive balance data. In some embodiments, the comprehensive balance data corresponds to one or more changes to the asset distribution parameters and/or the gift distribution parameters that would result in in each of the beneficiaries receiving an equal value of the assets and the gifts. In some embodiments, the value of the assets and the gifts can correspond to a monetary value of the assets and the gifts, an emotional value of the assets and the gifts, or a combination of the monetary value of the assets and the gifts and the emotional value of the assets and the gifts. For example, if the initial distribution data includes a first beneficiary associated with a first asset valued at $1,000 and a second beneficiary associated with a second asset valued at $500 based on asset distribution parameters from a will and the gift distribution data include the first beneficiary associated with a first gift valued at $1,500, the modeler circuit 124 can model the initial distribution data with the asset data and the gift distribution with the gift data to generate a comprehensive balance option that the will be modified to specify that the first asset and the second asset be associated with the second beneficiary such that the combined value of the assets and gifts associated with each of the beneficiaries is equal.

In some embodiments, the data control circuit 126 can be configured to perform data fusion operations, including operations to generate and/or various data structures stored in memory 120 and used by the various circuits described herein. For example, the data manager can communicate with the user device or data sources by collect, receiving, or identifying data relevant for use by the other circuits. The data control circuit 126 can also be configured to receive a plurality of entity data. In some arrangements, the data control circuit 126 can be configured to receive data regarding the network 130 as a whole instead of data specific to particular entity. The received data that the data control circuit 126 receives can be data that asset distribution system 110 aggregates and/or data that the asset distribution system 110 receives from the data sources 170 and/or any other system described herein (e.g., provider system 135, user device 140).

The content control circuit 128 can include circuitry for storing information such as rules for offering actionable activities for customized user data structures. The content control circuit 128 can receive data for determining or displaying actionable activities to the user from any component of the distribution modeler architecture 100 (e.g., receives associations between assets and beneficiaries from modeler circuit 124). The content control circuit 128 may additionally store this information in memory 120. In some embodiments, the content control circuit 128 can generate content for displaying to users. The content can be selected from various resources (e.g., a request for a photograph of an asset from the data control circuit 126). The content control circuit 128 can also be structured to provide content (e.g., via a graphical user interface (GUI)) to the user device 140 over the network 130, for display within the resources. For example, the content control circuit 128 can present a GUI including actionable elements illustrating associations between the assets and the beneficiaries. The GUI can be sent via the input/output device 132 to the user device 140 through the network 130.

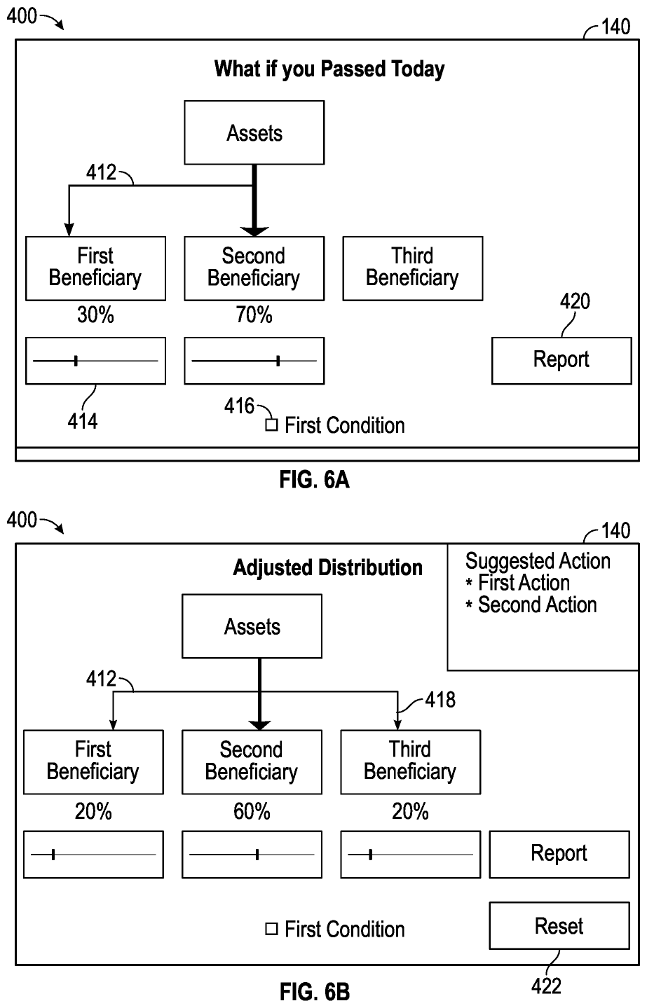

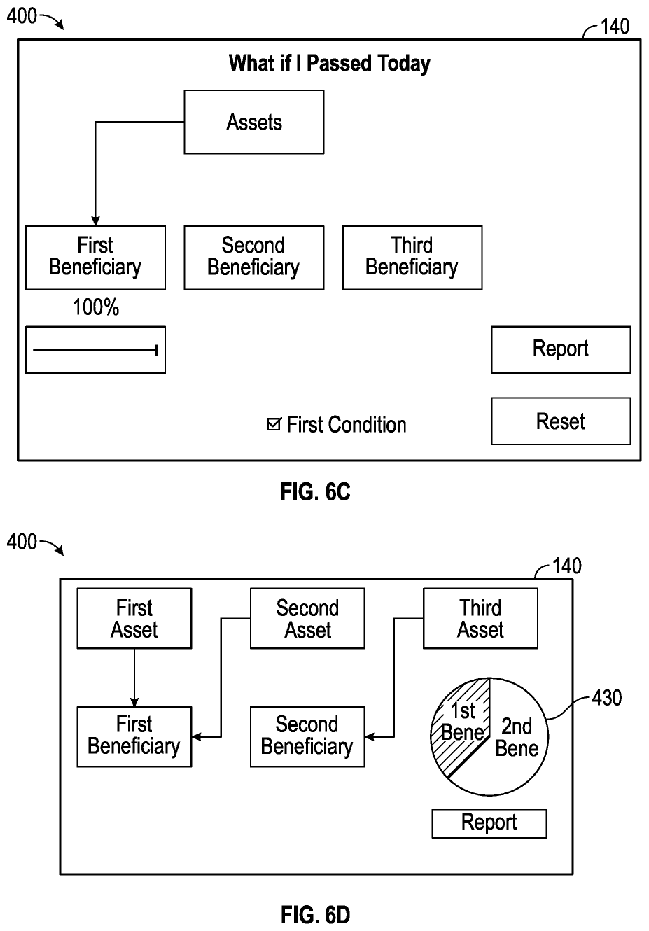

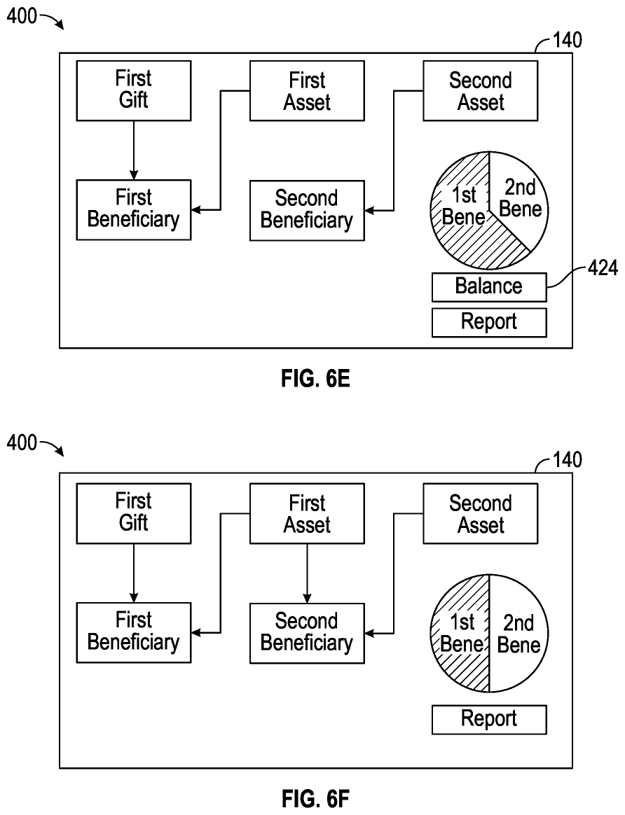

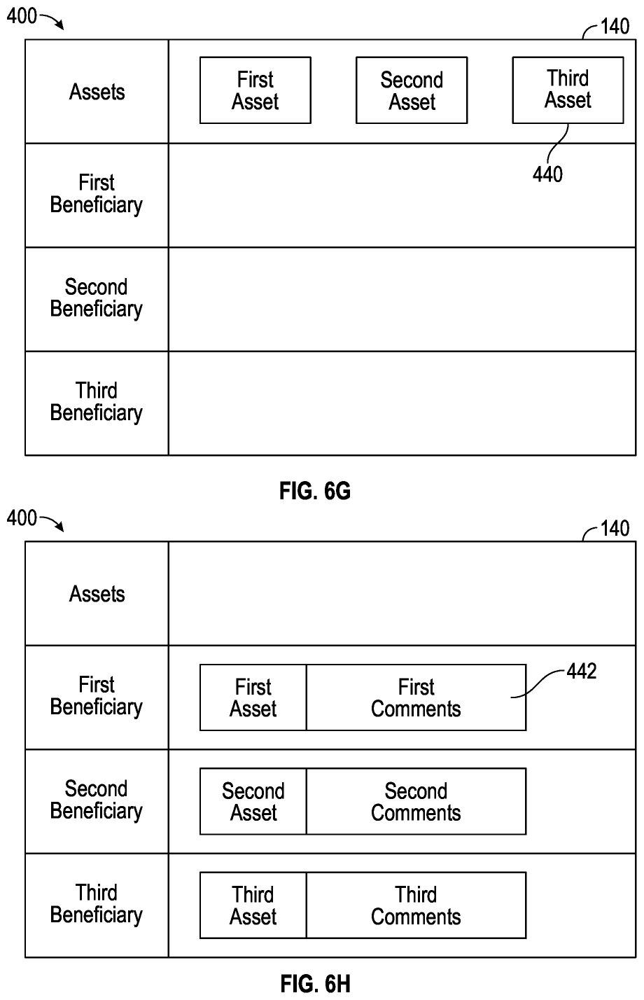

The content control circuit 128 can generate interfaces such as a plurality of customized dashboards, such as those described in detail below, with reference to FIGS. 6A-6H. The content control circuit 128 can generate customized user-interactive dashboards for one or more entities, such as the user device 140, based on data received from the user device 140, data source 170, and/or any other computing device described therein. The generated dashboards can include various data (e.g., data stored in the content control circuit 128 and/or modeling dataset 122) associated with one or more assets such as valuations, photographs or videos, descriptions, and/or others. In certain embodiments, the asset distribution system 110 includes an application programming interface (API) and/or a software development kit (SDK) that facilitate the integration of other applications with the asset distribution system 110. For example, the asset distribution system 110 is configured to utilize the functionality of the user device 140 interacting with the user client application 154 through an API.

The content control circuit 128 can generate initial display data based on the initial distribution data (e.g., generated by the modeler circuit 124). In some embodiments, the initial display data includes elements illustrating the associations between the assets and the beneficiaries. The elements may be configured as actionable items that allow for a user of the user device to perform a user adjustment on the elements that adjusts, a selection, a size and/or a location of the elements. The content control circuit 128 may then communicate the user adjustment to the modeler circuit 124 for further modeling. In some embodiments, the elements include a selection related to a condition associated with one of the assets or one of the beneficiaries. The selection may be a check box, a toggle, an icon, or another actionable element that may be selected. For example, the interface may include a check box proximate a first beneficiary that is associated with disinheriting the first beneficiary. The user of the user device may select the check box, which would result in the content control circuit 128 communicating the user adjustment of the selection of the check box associated with disinheriting the first beneficiary to the modeler circuit 124 for further modeling (e.g., to model the initial distribution data with the user adjustment to generate adjusted distribution data).

In some embodiments, the elements include arrows that indicate the association between the assets and the beneficiaries. A size of the arrows between the assets and the beneficiaries may be representative of a ratio of each of the assets that are associated to each of the beneficiaries. The user adjustment to the arrows may include dragging and dropping a new arrow from one of the assets to one of the beneficiaries, changing the size of the arrows, or otherwise manipulating the arrows. In some embodiments, the size of the arrows may be adjusted by using a slider associated with each of the arrows, by entering a ratio associated with the arrows, or by other adjustment to the interface. For example, the interface may include a first asset associated with a first beneficiary and a second asset associated with a second beneficiary. The interface may include a first arrow from the first asset to the first beneficiary and a second arrow from the second asset to the second beneficiary to indicate association between the assets and the beneficiaries. The user of the user device may drag and drop a third arrow from the first asset to the second beneficiary, which would result in the content control circuit 128 communicating the user adjustment of the dragging and dropping of the third arrow to the modeler circuit 124 for further modeling (e.g., to model the initial distribution data with the user adjustment to generate adjusted distribution data). As another example, the interface may include a first asset associated with a first beneficiary and a second beneficiary. The interface may include a first arrow from the first asset to the first beneficiary and a second arrow from the first asset to the second beneficiary that is the same size as the first arrow. The first arrow and the second arrow may indicate an association between the first asset and the first beneficiary and an association between the first asset and the second beneficiary. The user of the user device may increase the size of the first arrow (e.g., by using a slider, by entering a ratio, etc.), which would result in the content control circuit 128 communicating the user adjustment of the change in the size of the first arrow to the modeler circuit 124 for further modeling (e.g., to model the initial distribution data with the user adjustment to generate adjusted distribution data).

Still referring to FIG. 1, the input/output device 132 is structured to receive communications from and provide communications to users associated with the asset distribution system 110. The input/output device 132 is structured to exchange data, communications, instructions, etc. with an input/output component of the asset distribution system 110. In one embodiment, the input/output device 132 includes communication circuitry for facilitating the exchange of data, values, messages, and the like between the input/output device 132 and the components of the asset distribution system 110. In yet another embodiment, the input/output device 132 includes machine-readable media for facilitating the exchange of information between the input/output device and the components of the asset distribution system 110. In yet another embodiment, the input/output device 132 includes any combination of hardware components, communication circuitry, and machine-readable media.

In some embodiments, the input/output device 132 includes suitable input/output ports and/or uses an interconnect bus (not shown) for interconnection with a local display (e.g., a touchscreen display) and/or keyboard/mouse devices (when applicable), or the like, serving as a local user interface for programming and/or data entry, retrieval, or other user interaction purposes. As such, the input/output device 132 may provide an interface for the user to interact with various applications stored on the asset distribution system 110. For example, the input/output device 132 may include a keyboard, a keypad, a mouse, joystick, a touch screen, a microphone, a biometric device, a virtual reality headset, smart glasses, smart headsets, and the like. As another example, input/output device 132, may include, but is not limited to, a television monitor, a computer monitor, a printer, a facsimile, a speaker, and so on. As used herein, virtual reality, augmented reality, and mixed reality may each be used interchangeably, yet refer to any kind of extended reality, including virtual reality, augmented reality, and mixed reality.

The user devices 140 may each similarly include a network interface 142, a processing circuit 144, and an input/output device 160. The network interface 142, the processing circuit 144, and the input/output device 160 may be structured and function substantially similar to and include the same or similar components as the network interface 112, the processing circuit 114, and the input/output device 132 described above, with reference to the asset distribution system 110. Therefore, it should be understood that the description of the network interface 112, the processing circuit 114, and the input/output device 132 of the asset distribution system 110 provided above may be similarly applied to the network interface 142, the processing circuit 144, and the input/output device 160 of each of the user devices 140.

In some embodiments, the network interface 142 is similarly structured and used to establish connections with other computing systems (e.g., the asset distribution system 110, other of the user devices 140, and data sources 170) via the network 130. The network interface 142 may further include any or all of the components discussed above, with reference to the network interface 112. The processing circuit 144 similarly includes a memory 150 and a processor 146. The memory 150 and the processor 146 are substantially similar to the memory 120 and the processor 116 described above. Accordingly, the user devices 140 are similarly configured to run a variety of application programs and store associated data in a database of the memory 150 (e.g., user device dataset 152). For example, the user devices 140 may be configured to run an application such as the user client application 154 that is stored in the user device dataset 152. In another example, the user devices 140 may be configured to store various user data, such as, but not limited to, personal user device information (e.g., names, addresses, phone numbers, contacts, call logs, installed applications, and so on), user device authentication information (e.g., username/password combinations, device authentication tokens, security question answers, unique client identifiers, biometric data (such as digital representations of biometrics), geographic data, social media data, application specific data, and so on), and user device provider information (e.g., token information, account numbers, account balances, available credit, credit history, exchange histories, and so on) relating to the various accounts.

Particularly, the user client application 154 can be configured to communicate with the asset distribution system 110. As such, the user devices 140 can be communicably coupled to the asset distribution system 110 (e.g., through interactions with the modeler circuit 124, data control circuit 126, and content control circuit 128), and data sources 170. The user client application 154 may therefore communicate with the asset distribution system 110 and data sources 170 to perform a variety of functions. For example, the user client application 154 is similarly configured to receive user inputs (e.g., via a user interface of the user device 140) to complete interactions during a communication session with asset distribution system 110. For example, the user client application 154 may be used during a communication session via an API with the analysis system to request additional content, such as a review of an asset. Additionally, the user client application 154 is configured to output information to a display of user device 140 regarding information received from the asset distribution system 110. For example, the user client application 154 is configured to communicate with a user interface to show graphics regarding content associated with an asset, such as a photograph or video, a valuation, or a description. Further, a user response to a display of user device 140 regarding information from the asset distribution system 110 can send a message, task, or instruction to the asset distribution system 110 via the network 130 that allows for the modeling dataset 122, modeler circuit 124, data control circuit 126, and/or content control circuit 128 to perform an update.

The user client application 154 is further configured to communicate with the asset distribution system 110 to allow a user associated with the various user devices to update asset information and/or provide feedback during a communication session based on content from the modeler circuit 124, the data control circuit 126, or the content control circuit 128 via the input/output device 123. The user client application may also be structured to allow the user devices 140 to retrieve and submit requests associated with assets, the adjustment of elements (e.g., actionable elements, actionable items, etc.), asset distribution parameters, and/or any other type of necessary information to and/or from asset distribution system 110 during an established session, as required to complete the communication session for providing the asset distribution simulation. In some embodiments, the user client application may be configured to temporarily store the requests associated with assets, the adjustment of elements, asset distribution parameters, and/or any other type of necessary information, which may then be selectively transmitted to the asset distribution system 110 in response to a user input (e.g., received via the input/output device 160).

The input/output device 160 of each user device 140 may function substantially similar to and include the same or similar components as the input/output device 132 previously described, with reference to the asset distribution system 110. As such, it should be understood that the description of the input/output device 132 provided above may also be applied to the input/output device 160 of each of the user devices 140. In some embodiments, the input/output device 160 of each user device 140 is similarly structured to receive communications from and provide communications to a user associated with the user device 140.

The data sources 170 can provide data to the asset distribution system 110 and/or user device 140. In some arrangements, the data sources 170 can be structured to collect data from other devices on network 130 (e.g., user devices 140 and/or other third-party devices) and relay the collected data to the asset distribution system 110 and/or user device 140. In some embodiments, the asset distribution system 110 may request data associated with specific data stored in the data source (e.g., data sources 170). For example, in some arrangements, the data sources 170 can support a search or discovery engine for Internet-connected devices. The search or discovery engine may provide data from other providers that, when used to update an asset distribution parameter to modify the distribution of an asset (e.g., asset distribution parameter used by the modeler circuit 124 based on data from the modeling dataset 122), will cause an update to an asset associated with a beneficiary. The search or discovery engine may also provide data from other providers that, when used to update a valuation of an asset (e.g., valuation of an asset used by the modeler circuit 124 based on data from the modeling dataset 122), will cause an update to the initial distribution data associated with the assets and the beneficiaries.

In some embodiments, the distribution modeler architecture 100 can include provider systems 135. A provider system 135 can be communicated with to obtain or access additional asset data and asset distribution parameters, where the provider system 135 can be banks, credit unions, appraisers, governmental institutions, or other institutions (e.g., credit card companies, financial institutions (FI)). In some arrangements, provider systems 135 can provide data to the asset distribution system 110 and/or user device 140. In some arrangements, a provider system 135 can be structured to collect data from other devices on the network 130 (e.g., user devices 140 and/or other third-party devices) and relay the collected data to the asset distribution system 110 and/or user device 140. In some embodiments the asset distribution system 110 may request data associated with specific data stored in the provider system 135. For example, in some arrangements, the provider systems 135 can support a search or discovery engine for Internet-connected devices. The search or discovery engine may provide data from other providers that, when used to update asset data to update a value of an asset (e.g., an asset included in the asset data and associated with a beneficiary), will cause an update to the initial distribution data to take into account the update to the value of the asset. For example, the search or discovery engine may provide an updated valuation of a real estate property from a provider of real estate valuations (e.g., a real-estate marketplace company, etc.). The search or discovery engine may also provide data from other providers that, when used to update asset distribution parameters (e.g., asset distribution parameters used by the modeler circuit 124 based on data from the modeling dataset 122), will cause an update to the initial distribution data based on the update to the asset distribution parameters. For example, the search or discovery engine may provide an updated intestacy law from a state government (e.g., a change in a law governing the distribution of assets to beneficiaries).

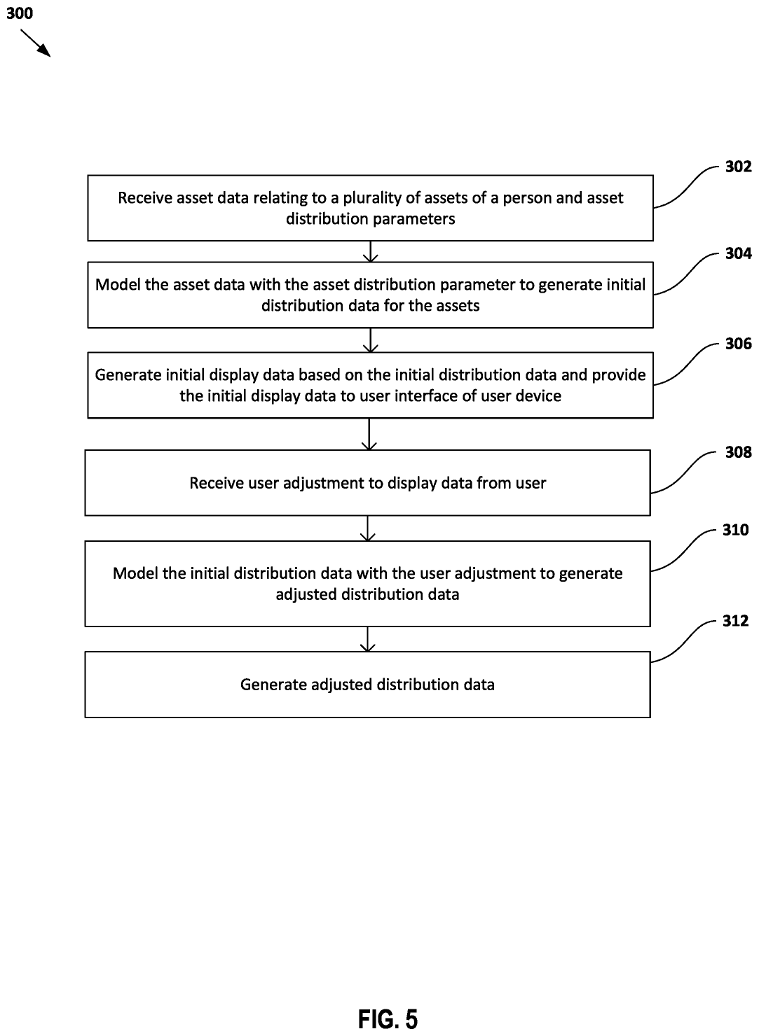

Referring now to FIG. 5, a flowchart for a method 300 of asset distribution modeling is shown, according to some embodiments. Asset distribution system 110 can be configured to perform method 300. Further, any computing device described herein can be configured to perform method 300.

In broad overview of method 300, at block 302, the one or more processing circuits (e.g., asset distribution system 110 in FIG. 1) can receive asset data relating to a plurality of assets of a person and asset distribution parameters. At block 304, the one or more processing circuits can model the asset data with the asset distribution parameters to generate initial distribution data for the assets. At block 306, the one or more processing circuits can generate initial display data based on the initial distribution data. At block 308, the one or more processing circuits can provide the initial display data to a user interface of a user device. At block 310, the one or more processing circuits can receive user adjustments to the display data from the user device. At block 312, the one or more processing circuits can model the initial distribution data with the user adjustment to generate adjusted distribution data by adjusting the associations between the beneficiaries and the assets of the initial distribution data based on the user adjustment. At block 314, the one or more processing circuits can generate adjusted display data based on the adjusted distribution data and provide the adjusted display data to the user interface. Additional, fewer, or different operations may be performed depending on the particular arrangement. In some embodiments, some, or all operations of method 300 may be performed by one or more processors executing on one or more computing devices, systems, or servers. In various embodiments, each operation may be re-ordered, added, removed, or repeated.

The GUI of method 300 may be provided by and/or accessible by the user client application 154 and content control circuit 128, for example. The method 300 may be performed by the asset distribution system 110 or the user device 140, described above pertaining to FIGS. 1 & 2. In some embodiments, method 300 begins in response to receiving, by a user device (e.g., user device 140) and/or through a user client application (e.g., user client application 154), data from a dataset (e.g., user device dataset 152). The data can include asset data relating to assets or user data. In some embodiments, method 300 begins when the asset distribution system 110 receives data via the network 130.

Referring now to FIG. 5 in more detail at block 302, the one or more processing circuits can receive asset data relating to assets of a person and asset distribution parameters. In some embodiments, the asset data and the asset distribution parameters may be received from a graphical user interface (GUI) presented on the user device 140 via the network 130. In various embodiments, the asset data and the asset distribution parameters may be received from the data source 170 or the provider system 135 via the network 130. The asset data may include names of the assets, valuations of the assets, photographs of the assets, or other information relating to the assets. In some embodiments, the user device 140 may provide the asset data and the asset distribution parameters after receiving an input to a user interface of the user device. For example, a user may request that an asset distribution analysis be performed through the user interface of the user device 140 and may also upload asset data relating to the assets and asset distribution parameters relating to the assets and to beneficiaries to the user device 140. The asset distribution parameters uploaded by the user may include all of the asset distribution parameters or method 300 may need to receive additional asset distribution parameters from a different source (e.g., the provider system 135, the data source 170, etc.).

In some embodiments, the processing circuit can receive gift data relating to gifts (e.g., one or more gifts, etc.) of the person and gift distribution parameters. In some embodiments, the gifts have been previously gifted by the person to the beneficiaries. In some embodiments, the gift data and the gift distribution parameters may be received from the GUI presented on the user device 140 via the network 130. In various embodiments, the gift data and the gift distribution parameters may be received from the data source 170 or the provider system 135 via the network 130. The gift data may include names of the gifts, valuations of the gifts, photographs of the gifts, or other information relating to the gifts. In some embodiments, the user device 140 may provide the gift data and the gift distribution parameters after receiving an input to the user interface of the user device. For example, a user may request that a gift distribution analysis be performed through the user interface of the user device 140 and may also upload gift data relating to the gifts and gift distribution parameters relating to the gifts and to beneficiaries to the user device 140. The gift distribution parameters uploaded by the user may include all of the gift distribution parameters or method 300 may need to receive additional gift distribution parameters from a different source (e.g., the provider system 135, the data source 170, etc.).

At block 304, the one or more processing circuits can model the asset data with the asset distribution parameters received at block 302 to generate initial distribution data for the assets. In some embodiments, the initial distribution data corresponds to initial associations between beneficiaries and the assets based on the asset distribution parameters. For example, the model of the method may compare a first asset with the asset distribution parameters associated with a will. If the first asset is included in the asset distribution parameters associated with the will, then the model may generate associations between the first asset and beneficiaries that correspond to the asset distribution parameters that are included in the will and correspond to the first asset. If the first asset is not included in the asset distribution parameters associated with the will, then the model may generate associations between the first asset and beneficiaries included in other asset distribution parameters that correspond to the first asset. For example, the method at block 306 may compare a vehicle with a will. If the vehicle is included in the will and the will specifies that the vehicle should be passed on to a brother, then the processing circuit may generate an association between the vehicle and the brother. If the vehicle is not included in the will, then asset distribution parameter relating to the vehicle may be an intestacy law. If the intestacy law states that the vehicle should be passed on to a spouse, then the processing circuit may generate an association between the vehicle and the spouse.

In some embodiments, the process of modeling can include using techniques such as machine learning, statistical analysis, and pattern recognition to establish relationships between the asset data and the asset distribution parameters and generate initial distribution data based on those relationships. In some embodiments, modeling can begin with the selection of an appropriate model based on the asset data and the asset distribution parameters. It should be understood that the term modeling herein encompasses a wide range of techniques and approaches aimed at understanding relationships within data. This could include anything from statistical methods and rule-based systems to machine learning algorithms, depending on the nature of the data. Thus, modeling involves selecting techniques based on the specific characteristics of the data, ensuring that the chosen method or methods accurately captures relationships.

In some embodiments, the processing circuit can utilize pattern recognition methodologies to identify associations between the assets and the beneficiaries associated with the asset data and the asset distribution parameters received at block 302 and utilize that data to determine the resulting initial distribution data that includes those associations. For example, pattern recognition may be applied to the asset distribution parameters to discern repeated associations between like assets and like beneficiaries. By integrating these repeated associations, the processing circuit can generate initial distribution data that associates the like asset and the like beneficiaries. For example, the processing circuit can identify that the asset distribution parameters include repeated associations between real estate assets and a spouse. The processing circuits can then model the asset data with the asset distribution parameters to generate initial distribution data that includes associations between each of the real estate assets and the spouse.

In some embodiments, the processing circuit can model the gift data with the gift distribution parameters to generate gift distribution data for the gifts. In some embodiments, the gift distribution data corresponds to associations between the beneficiaries and the gifts based on the gift distribution parameters. For example, the model of the method may compare a first gift with the gift distribution parameters. If the gift distribution parameters includes that the first gift was gifted to a friend, then the model may generate an association between the first gift and the friend. After generating the gift distribution data, the processing circuit can update the initial distribution data to include the gift distribution data.

At block 304, the one or more processing circuits can model the asset data with the asset distribution parameters received at block 302 to generate initial distribution data for the assets. In some embodiments, the initial distribution data corresponds to initial associations between beneficiaries and the assets based on the asset distribution parameters. In some embodiments, the process of modeling can include using techniques such as machine learning, statistical analysis, and pattern recognition to establish relationships between the asset data and the asset distribution parameters and generate initial distribution data based on those relationships. In some embodiments, modeling can begin with the selection of an appropriate model based on the asset data and the asset distribution parameters. It should be understood that the term modeling herein encompasses a wide range of techniques and approaches aimed at understanding relationships within data. This could include anything from statistical methods and rule-based systems to machine learning algorithms, depending on the nature of the data. Thus, modeling involves selecting techniques based on the specific characteristics of the data, ensuring that the chosen method or methods accurately captures relationships.

In some embodiments, the model parameters can be trained and optimized using the cleaned, classified, and linked asset data, asset distribution parameters, gift data, and gift distribution parameters. This training process can include using algorithms to adjust the model parameters such that the error between the model's predictions and the actual outcomes is minimized. The modeling process can also include feature engineering, which is the process of creating new features or modifying existing ones to improve the model's power. For example, instead of modeling initial associations between the assets and a state government as a beneficiary, a feature that sets the initial associations between the assets and the beneficiaries as associations between the assets and the state government and then updates the beneficiaries as determined by modeling the asset data with the asset distribution parameters might result in a more efficient model due to the fact that the assets without any prescribed associations may be associated to the state government.

Once one or more models or techniques are trained and/or optimized, the processing circuits can use the model to generate initial distribution data. The initial distribution data could be a mathematical representation, a decision tree, a set of rules, or any other structure that captures the relationships between different data points. Moreover, the modeling process can include various safeguards to ensure privacy and security of user data (e.g., anonymizing the data).

In some embodiments, the processing circuits can use rule-based systems to model the asset data and the asset distribution parameters. Rule-based systems can be predefined rules that are created by the processing circuits (or domain experts) to infer outcomes based on given conditions. For example, if the asset distribution parameters received at block 302 include both an account level document and a will, a rule might state that the account level document takes priority over the will. This rule can then be applied to the process to limit the process to modeling the asset data with only the asset distribution parameters related to the account level document for the asset data related to the assets included in the asset distribution parameters. In some embodiments, the processing circuit can use statistical methods for modeling.

Referring now to FIG. 5 in more detail at block 306, the processing circuit can generate initial display data based on the initial distribution data and provide the initial display data to a user interface of a user device. In some embodiments, the initial display data includes a plurality of elements illustrating the associations between the assets and the beneficiaries. In some embodiments, the method at block 306 can present the GUI through the operating system of the user device, display hardware of the user device, graphics rendering of the user device, windowing system of the user device, among other means. For example, the GUI system can incorporate event-driven programming, where actions or events trigger corresponding responses. In some embodiments, the operation system and applications of the devices used by the method can use implementations such as event handlers to update the GUI.

Still referring to FIG. 5 in more detail at block 306, the one or more processors can establish a communication session between the asset distribution system 110 and other external systems or devices such as a user device. To establish a communication session via an application programming interface, the method at block 306 could establish connections through connection initiation, addressing and identification, handshake and negotiation, authentication and authorization, channel establishment, data exchange, or session maintenance. The exact process and protocols used to establish a communication session can vary depending on the specific devices, network infrastructure, and communication technologies involved. Different protocols, such as TCP/IP, Bluetooth, Wi-Fi, or specific application-layer protocols, have their own mechanisms for session establishment. When initiating a connection, the initiating device, which can be referred to as the client, sends a request to establish a connection with the target device, which can be the server. This request can be initiated through various means, such as a physical cable connection, wireless signals, or network protocol. Addressing and identification involves the initiating device specifying the address or identifier of the target device it wishes to communicate with. This can be an IP address, domain name, MAC address, or any other unique identifier depending on the communication protocol being used. Handshake and negotiation involve the devices engaging in a handshake process to negotiate communication parameters and establish a common set of rules for the session. This includes agreeing on protocols, encryption methods, data formats, and other communication settings. Authentication and authorization involve the devices performing authentication and authorization procedures to ensure the identity and permissions of each other. This can involve exchanging credentials, digital certificates, or other security measures to validate the devices' authenticity and grant access to the requested resources. Channel establishment follows the process of once the handshake is successful and authentication is completed, the devices establish a communication channel. This can involve creating a logical connection, allocating network resources, or establishing a secure tunnel to facilitate data exchange. Data Exchange involves establishing a communication channel, and then allowing the devices to start exchanging data. This can involve sending messages, transmitting files, streaming media, or any other form of information exchange based on the intended purpose of the session. Session maintenance involves the devices periodically exchanging control messages to ensure the session remains active and monitor the connection's integrity during the communication session. This includes handling potential errors, retransmission of lost data, and managing any necessary protocol-specific maintenance tasks.

Still referring to FIG. 5 in more detail at block 306, the initial display data may include elements illustrating the associations between the assets and the beneficiaries. The elements may be configured as actionable items that allow for a user of the user device to perform a user adjustment on the elements that adjusts a selection, a size and/or a location of the elements. In some embodiments, the elements include a selection related to a condition associated with one of the assets or one of the beneficiaries. The selection may be a check box, a toggle, an icon, or another actionable element that may be selected. In some embodiments, the elements include arrows that illustrate the association between the assets and the beneficiaries. A size of the arrows between the assets and the beneficiaries may be representative of a ratio of each of the assets that are associated to each of the beneficiaries. In some embodiments, each of the arrows may include a sliding scale for adjusting the size of each of the arrows.

Referring now to FIG. 5 in more detail at block 308, the one or more processing circuits can receive a user adjustment to at least one of the elements of the plurality of elements from the user device. For example, after generating initial display data based on the initial distribution data and providing the initial display data to a user interface of the user device at block 306, a user of the user device can make an adjustment to one of the elements illustrating the associations between the assets and the beneficiaries. The user device 140 can then send the exchange request to the processing circuit (e.g., from the input/output device 160 via the network 130 and the input/output device 132, etc.). In some embodiments, the user adjustment may include dragging and dropping a new arrow from one of the assets to one of the beneficiaries, changing the size of the arrows, or selecting a condition associated with one of the beneficiaries.

Referring now to FIG. 5 in more detail at block 310, the one or more processing circuits can model the initial distribution data with the user adjustment to generate adjusted distribution data by adjusting the one or more associations between the one or more beneficiaries and the one or more assets of the initial distribution data based on the user adjustment. For example, the model of the method may determine that the element that received the user adjustment corresponded to one of the associations between one of the assets and one of the beneficiaries and determine a scope of the user adjustment. The model may then adjust the association between the one of the assets and the one of the beneficiaries in the initial distribution data based on the scope of the user adjustment to generate the adjusted distribution data. For example, the initial distribution data may include an association between a first asset and a first beneficiary and a user adjustment may be to drag and drop a new arrow from the first asset to a second beneficiary. The model may then determine that the user adjustment added an element between the first asset and the second beneficiary and adjust the initial distribution data to include an association between the first asset and the second beneficiary to form the adjusted distribution data. In some embodiments, the process of modeling can include using techniques and methods discussed for the modeling performed at block 308.

In some embodiments, the user adjustment may be selecting an excluding condition associated with one of the beneficiaries and the processing circuit may model the initial distribution data with the user adjustment to generate the adjusted distribution data by reassociating the assets allocated with the one of the beneficiaries to a remainder of the beneficiaries. For example, the user adjustment may be to select a condition associated with a child that is associated with disinheriting the child. The model may determine that the user adjustment selected the element associated with removing all associations between the child and the assets and adjust the initial distribution data to remove all associations between the child and the assets to form the adjusted distribution data.

In some embodiments, the processing circuit can identify and model a variation between the initial distribution data and the adjusted distribution data with the asset distribution parameters to generate suggestion data. In some embodiments, the suggestion data corresponds to changes to the asset distribution parameters that would reduce the variations between the initial distribution data and the adjusted distribution data. For example, the model of the method may identify a difference between the initial distribution data and the adjusted distribution data that was modeled from a user adjustment. The model may then model the difference with the asset distribution parameters to determine a suggested change to one of the elements making up the asset distribution parameters that would cause the initial distribution data to match the adjusted distribution data modeled by the user adjustment. For example, the model may identify that an ex-spouse is included as one of the beneficiaries in the initial distribution data of a person, but is not included as one of the beneficiaries in the adjusted distribution data. The model may then model the ex-spouse with a will and an intestacy law making up the asset distribution parameters to determine that the ex-spouse is associated with a portion of the assets due to the intestacy law and that the will should be updated to include the portion of the assets and a beneficiary of the portion of the assets to bring the asset distribution parameters in line with the wishes of the person based on the adjusted distribution data.

In some embodiments, the processing circuit can modify the asset distribution parameters with the changes of the suggestion data. The modification of the asset distribution parameters may be automatically initiated after generating the suggestion data or the modification may initiate in response to a user input. For example, the processing circuit may modify a will that makes up a portion of the asset distribution parameters based on the suggestion data corresponding to a change to the will that would reduce the differences between the initial distribution data and the adjusted distribution data after a user device provides a selection of an actionable element corresponding to modifying the will making up the portion of the asset distribution parameters.

Referring now to FIG. 5 in more detail at block 312, the processing circuit can generate adjusted display data based on the adjusted distribution data and provide the adjusted display data to the user interface. In some embodiments, the method at block 312 can present the GUI through the operating system of the user device, display hardware of the user device, graphics rendering of the user device, windowing system of the user device, among other means. For example, the GUI system can incorporate event-driven programming, where actions or events trigger corresponding responses. In some embodiments, the operation system and applications of the devices used by the method can use implementations such as event handlers to update the GUI. The processing circuit can also establish a communication between the asset distribution system 110 and other external system or devices using similar connections as described in more detail with respect to block 306.

In some embodiments, the processing circuit can generate suggestion display data of the suggestion data and provide the suggestion display data to the user interface. In some embodiments, the suggestion display data may include an actionable element (e.g., at least one actionable element, etc.) corresponding to the suggestion display data. For example, the suggestion display data may include a suggestion to make a change to a will to reduce the variations between the initial distribution data and the adjusted distribution data and a button that corresponds to the suggestion display data. In some embodiments, the selection of the actionable item causes the processing circuit to proceed with modifying the asset distribution parameters based on the suggestion data.

In some embodiments, the processing circuit can receive a request for a distribution report from a user device (e.g., a user request for a distribution report, etc.), and generate and provide the distribution report to the user interface. In some embodiments, the distribution report include a graphical summary of the assets associated with each of the beneficiaries. The distribution report may include descriptions of the assets, photographs of the assets, and other information relating to the assets. The distribution report may also include descriptions of the beneficiaries, photographs of the beneficiaries, and other information relating to the beneficiaries. For example, the graphical summary may include a photograph of each of the beneficiaries next to a photograph of the assets associated with the each of the beneficiaries. In some embodiments, the distribution report may include a family tree relating to the beneficiaries.

In some embodiments, the distribution report may include a selection of the assets that are not associated with any of the beneficiaries. The distribution report may include a selection interface that allows for the beneficiaries to select any of the selection of the assets that are not associated with any of the beneficiaries. In some embodiments, the selecting of the assets in the selection interface may include the ability to swipe on the assets to show interest or uninterest, the ability to spin a wheel to determine the association between the assets and one of the beneficiaries, or other means to associate the assets with the beneficiaries.

Referring now to FIG. 6A, an illustration of a configuration of a user interface 400 on user device 140 is shown. The user interface 400 may be presented within the user client application 154. In some embodiments, the user interface 400 is generated and provided by the content control circuit 128. The user interface 400 can contain content related to assets such as photographs and descriptions. The user interface can also contain content related to beneficiaries such as names, photographs, and descriptions. The user interface 400 can also contain one or more arrows (e.g., 412) that correspond to associations between the assets and the beneficiaries. In some embodiments, the arrows may have a feature that can be modified (e.g., modify the length of the arrow, modify the thickness of the arrow, modify the color of the arrow, etc.) that corresponds to the size of the association between the assets and the beneficiaries. For example, as illustrated, a first arrow between an asset and a first beneficiary may be thinner than a second arrow between the asset and a second beneficiary if 70% of the asset is associated with the second beneficiary and 30% of the asset is associated with the first beneficiary. A user may modify the feature of the arrow through an actionable activity corresponding to the arrows. In some embodiments, the actionable activity corresponding to the arrows may be one or more slider elements (e.g., 414) associated with the one or more arrows. The slider elements may be modified by a user to modify the feature of the arrows. In some embodiments, sliding one of the slider elements to the left may decrease the size of one of the arrows and sliding the one of the slider elements to the right may increase the size of the one of the arrows. For example, sliding one of the sliders to the right may increase the thickness of one of the arrows and sliding the one of the sliders to the left may decrease the thickness of the one of the arrows. The slider elements may also include a numerical indicator related to a position of the slider element (e.g., a percentage, a ratio, etc.). The user interface 400 can also contain one or more condition elements (e.g., 416) associated with the assets or the beneficiaries that influences an actionable activity. The condition elements, if selected by the user, may add or remove arrows corresponding to the association between assets and beneficiaries. In some embodiments, the condition elements may include a description of a condition related to the condition element. For example, the condition element could be related to disinheriting one of the beneficiaries and the description could be “Disinherit”. The user interface 400 can also contain a first actionable activity or action (e.g., 420). In some embodiments, the user interface 400 may contain one or more first actionable (or interactable) buttons or items (e.g., 420) that influences a first actionable activity. In some embodiments, the first actionable button 420, if selected by the user, generates a report on the associations between the assets and the beneficiaries, generates a visual display of the value of assets associated with each of the beneficiaries, generates a visual display of the value of assets and the value of gifts associated with each of the beneficiaries, and/or other mechanisms to assist a user to visualize the distribution of the assets of the user. In some embodiments, the user device 140 is a mobile device, such as a cellular phone and/or smart phone.

Referring now to FIG. 6B, an illustration of a configuration of the user interface 400 on user device 140 is shown. The user interface 400 may be presented within the user client application 154. In some embodiments, the user interface 400 is generated and provided by the content control circuit 128. The user interface 400 can include the content related to the assets and the beneficiaries, the arrows 412, the slider elements 414, the condition elements 416, and the first actionable activity 420 described in relation to FIG. 6A above. The user interface 400 can include a user generated arrow (e.g., 418) between one of the assets and one of the beneficiaries that may be added to the user interface 400 by a user by dragging and dropping the user generated arrow from the one of the assets to the one of the beneficiaries. In some embodiments, when the user generated arrow 418 is added to the user interface 400 by the user, the feature that can be modified of the arrows 412 may be modified in response to the addition of the user generated arrow 418. For example, a first arrow is between an asset and a first beneficiary and 30% of the asset is associated with the first beneficiary and a second arrow is between the asset and the second beneficiary and 70% of the asset is associated with the second beneficiary. If a user generated arrow is added between the asset and a third beneficiary to associate 20% of the asset with the third beneficiary, then a size (e.g., weight/thickness) of the first arrow may decrease as the portion of the asset associated with the first beneficiary decreases from 70% to 60% and a size (e.g., weight/thickness) of the second arrow may also decrease as the portion of the asset associated with the second beneficiary decreases from 30% to 20%. The user interface 400 can also contain a second activity or action (e.g., 422). In some embodiments, the user interface 400 may contain one or more second actionable (or interactable) buttons or items (e.g., 422) that influences a second actionable activity. In some embodiments, the second actionable button 422, if selected by the user, resets the user interface 400 to display the initial display data, reverses the user adjustments made to the arrows, reverses the user adjustments made to the condition elements, removes the user generated arrow, and or other mechanisms to assist the user to reset the user interface 400 to an initial condition of the user interface 400.

Referring now to FIG. 6C, an illustration of a configuration of the user interface 400 on user device 140 is shown. The user interface 400 may be presented within the user client application 154. In some embodiments, the user interface 400 is generated and provided by the content control circuit 128. The user interface 400 can include the content related to the assets and the beneficiaries, the arrows 412, the slider elements 414, the condition elements 416, and the first actionable activity 420 described in relation to FIG. 6A above. In some embodiments depicted in FIG. 6C, the user interface 400 depicts the selection of the condition element 416 by the user from the embodiment shown in FIG. 6A. The selection of the condition element 416 results in a removal of the one of the arrows from the asset to the second beneficiary and an indication in the condition element that the condition element has been selected. The selection of the condition element 416 also results in the slider element 414 associated with the first beneficiary moving all the way to the right to indicate that an entirety of the asset is now associated with the first beneficiary.

Referring now to FIG. 6D, an illustration of a configuration of the user interface 400 on user device 140 is shown. The user interface 400 may be presented within the user client application 154. In some embodiments, the user interface 400 is generated and provided by the content control circuit 128. The user interface 400 can include the content related to the assets and the beneficiaries, the arrows 412, and the first actionable activity 420 described in relation to FIG. 6A above. In some embodiments depicted in FIG. 6D, the user interface 400 can contain content related to gifts such as photographs and descriptions. Additionally, the arrows 412 may also correspond to associations between the gifts and the beneficiaries The user interface 400 can also include a visualization element (e.g., 430). The visualization element 430 may depict a value of the assets and the gifts associated with each of the beneficiaries. The visualization element 430 may be a pie chart, a bar graph, a ratio or another visualization of the values of the assets and gifts associated with each of the beneficiaries. In some embodiments, the visualization element may be associated with the initial distribution data and may be an initial pie chart, an initial bar graph, an initial ratio, or another visualization of an initial value of the assets and gifts associated with each of the beneficiaries corresponding to the initial distribution data.

Referring now to FIG. 6E, an illustration of a configuration of the user interface 400 on user device 140 is shown. The user interface 400 may be presented within the user client application 154. In some embodiments, the user interface 400 is generated and provided by the content control circuit 128. The user interface 400 can include the content related to the assets and the beneficiaries, the arrows 412, and the first actionable activity 420 described in relation to FIG. 6A above and the visualization element 430 described in relation to FIG. 6D above. The user interface 400 can also contain a third second activity or action (e.g., 424). In some embodiments, the user interface 400 may contain one or more third actionable (or interactable) buttons or items (e.g., 424) that influences a third actionable activity. In some embodiments, the third actionable button 424, if selected by the user, balances the value of the assets associated with each of the beneficiaries, balances the value of the gifts and the value of the assets associated with each of the beneficiaries, balances a combined value of both the value of the gifts and the value of the assets associated with each of the beneficiaries, and or other mechanisms to assist the user to balance the value of the assets and the value of the gifts associated with each of the beneficiaries.

Referring now to FIG. 6F, an illustration of a configuration of the user interface 400 on user device 140 is shown. The user interface 400 may be presented within the user client application 154. In some embodiments, the user interface 400 is generated and provided by the content control circuit 128. The user interface 400 can include the content related to the assets and the beneficiaries, the arrows 412, and the first actionable activity 420 described in relation to FIG. 6A above and the visualization element 430 described in relation to FIG. 6D above. In some embodiments depicted in FIG. 6F, the user interface 400 depicts the selection of the third actionable button 424 by the user from the embodiment shown in FIG. 6A. The selection of the third actionable button 424 results in a redistribution of the arrows between the gifts and the beneficiaries and the arrows between the assets and the beneficiaries such that the combined value of both the value of the assets and the value of the gifts associated with each of the beneficiaries is balanced. The visualization element 430 is also updated to show that the combined value associated 430 with each of the beneficiaries is balanced. In some embodiments, the visualization element 430 may be updated to be associated with the adjusted distribution data and may be an adjusted pie chart, an adjusted bar graph, an adjusted ratio, or another visualization of an adjusted value of the assets and gifts associated with each of the beneficiaries corresponding to the adjusted distribution data.

Referring now to FIG. 6G, an illustration of a configuration of the user interface 400 on user device 140 is shown. The user interface 400 may be presented within the user client application 154. In some embodiments, the user interface 400 is generated and provided by the content control circuit 128. The user interface 400 can include the content related to the assets and the beneficiaries described in relation to FIG. 6A above. The user interface 400 can also be divided up into a section for each of the beneficiaries. In some embodiments, the sections for each of the beneficiaries may be labeled as a vault. The user interface 400 can also include moveable asset elements (e.g., 440) associated with each of the assets. The moveable asset elements 440 may be selected by a user and moved into one of the sections for each of the beneficiaries. In some embodiments, the moveable asset elements 440 may be moved by dragging and dropping the moveable asset elements 440.

Referring now to FIG. 6H, an illustration of a configuration of the user interface 400 on user device 140 is shown. The user interface 400 may be presented within the user client application 154. In some embodiments, the user interface 400 is generated and provided by the content control circuit 128. The user interface 400 can include the content related to the assets and the beneficiaries described in relation to FIG. 6A above and the sections for each of the of the beneficiaries and the moveable asset element 440 described in relation to FIG. 6G above. In some embodiments depicted in FIG. 6H, the user interface 400 depicts a movement of the moveable asset elements 440 into the sections for each of the beneficiaries. In some embodiments, the moveable asset elements 440 may include a comment box (e.g., 442) that may contain comments relating to the moveable asset elements 440. In some embodiments, the seconds for each of the beneficiaries and the moveable asset elements 440 may be shared with each of the beneficiaries.

It should be understood that no claim element herein is to be construed under the provisions of 35 U.S.C.§ 112(f) unless the element is expressly recited using the phrase “means for.”

As used herein, the term “circuitry” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory).

Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Example systems and devices in various embodiments might include a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the smart table system may be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A system comprising:
a processing circuit comprising memory and one or more processors, the processing circuit configured to:
receive asset data relating to one or more assets of a person and asset distribution parameters;
model the asset data with the asset distribution parameters to generate initial distribution data for the assets, wherein the initial distribution data corresponds to one or more initial associations between one or more beneficiaries and the one or more assets based on the asset distribution parameters;
generate initial display data based on the initial distribution data and provide the initial display data to a user interface of a user device, wherein the initial display data comprises a plurality of elements relating to the one or more associations between the one or more assets and the one or more beneficiaries;
receive a user adjustment to at least one of the elements of the plurality of elements from the user device;
model the initial distribution data with the user adjustment to generate adjusted distribution data by adjusting the one or more associations between the one or more beneficiaries and the one or more assets of the initial distribution data based on the user adjustment; and
generate adjusted display data based on the adjusted distribution data and provide the adjusted display data to the user interface.

2. The system of claim 1, wherein the plurality of elements include one or more arrows illustrating associations between the one or more assets and the one or more beneficiaries; and
wherein the user adjustment is at least one of dragging and dropping a new arrow from one of the assets to one of the beneficiaries, changing a size of the one or more arrows, or selecting a condition associated with one of the beneficiaries.

3. The system of claim 2, wherein the size of the one or more arrows from each of the assets to each of the beneficiaries is representative of a ratio of a portion of each of the assets allocated to each of the beneficiaries; and
wherein the user adjustment comprises changing the size of the one or more arrows using a sliding scale.

4. The system of claim 1, wherein the processing circuit is further configured to:
identify one or more variations between the initial distribution data and the adjusted distribution data;
model the one or more variations between the initial distribution data and the adjusted distribution data with the asset distribution parameters to generate suggestion data, wherein the suggestion data corresponds to one or more changes to the asset distribution parameters that would reduce the one or more variations between the initial distribution data and the adjusted distribution data; and
generate suggestion display data of the suggestion data and provide the suggestion display data to the user interface.

5. The system of claim 4, wherein the suggestion display data comprises at least one actionable element; and
wherein in response to a selection of the at least one actionable element, the processing circuit is further configured to modify the asset distribution parameters with the one or more changes of the suggestion data.

6. The system of claim 1, the processing circuit is further configured to:
receive gift data relating to one or more gifts of the person and gift distribution parameters, wherein the gifts have been previously gifted by the person;
model the gift data with the gift distribution parameters to generate gift distribution data for the one or more gifts, wherein the gift distribution data corresponds to one or more associations between one or more beneficiaries and one or more gifts based on the gift distribution parameters; and
update the initial distribution data to include the gift distribution data.

7. The system of claim 1, wherein the processing circuit is further configured to:
receive a user request for a distribution report from the user device; and
generate and provide the distribution report to the user interface, wherein the distribution report comprises a graphical summary of the one or more assets associated with each of the beneficiaries.

8. The system of claim 1, wherein the user adjustment comprises selecting an excluding condition associated with one of the beneficiaries; and
wherein the initial distribution data is modeled with the user adjustment to generate the adjusted distribution data by reallocating the one or more assets associated with the one of the beneficiaries to a remainder of the beneficiaries.

9. The system of claim 1, wherein the initial display data further comprises an initial pie chart displaying an initial ratio of an initial value of the one or more assets associated with each of the beneficiaries to a combined value of all of the assets; and
wherein the adjusted display data further comprises an adjusted pie chart displaying an adjusted ratio of an adjusted value of the one or more assets associated with each of the beneficiaries to the combined value of all of the assets.

10. A method comprising:
receiving, by a processing circuit, asset data relating to one or more assets of a person and asset distribution parameters;
modeling the asset data with the asset distribution parameters to generate initial distribution data for the assets, wherein the initial distribution data corresponds to one or more initial associations between one or more beneficiaries and the one or more assets based on the asset distribution parameters;
generating initial display data based on the initial distribution data and providing the initial display data to a user interface of a user device, wherein the initial display data comprises a plurality of elements relating to the one or more associations between the one or more assets and the one or more beneficiaries;
receiving a user adjustment to at least one of the elements of the plurality of elements from the user device;
modeling the initial distribution data with the user adjustment to generate adjusted distribution data by adjusting the one or more associations between the one or more beneficiaries and the one or more assets of the initial distribution data based on the user adjustment; and
generating adjusted display data based on the adjusted distribution data and providing the adjusted display data to the user interface.

11. The method of claim 10, wherein the plurality of elements include one or more arrows illustrating associations between the one or more assets and the one or more beneficiaries; and
wherein the user adjustment is at least one of dragging and dropping a new arrow from one of the assets to one of the beneficiaries, changing a size of the one or more arrows, or selecting a condition associated with one of the beneficiaries.

12. The method of claim 11, wherein the size of the one or more arrows from each of the assets to each of the beneficiaries is representative of a ratio of a portion of each of the assets allocated to each of the beneficiaries; and
wherein the user adjustment comprises changing the size of the one or more arrows using a sliding scale.

13. The method of claim 10, further comprising:
identifying one or more variations between the initial distribution data and the adjusted distribution data;
modeling the one or more variations between the initial distribution data and the adjusted distribution data with the asset distribution parameters to generate suggestion data, wherein the suggestion data corresponds to one or more changes to the asset distribution parameters that would reduce the one or more variations between the initial distribution data and the adjusted distribution data; and
generating suggestion display data of the suggestion data and providing the suggestion display data to the user interface.

14. The method of claim 13, wherein the suggestion display data comprises at least one actionable element; and
wherein in response to a selection of the at least one actionable element, the processing circuit is further configured to modify the asset distribution parameters with the one or more changes of the suggestion data.

15. The method of claim 10, further comprising:
receiving gift data relating to one or more gifts of the person and gift distribution parameters, wherein the gifts have been previously gifted by the person;
modeling the gift data with the gift distribution parameters to generate gift distribution data for the one or more gifts, wherein the gift distribution data corresponds to one or more associations between one or more beneficiaries and one or more gifts based on the gift distribution parameters; and
updating the initial distribution data to include the gift distribution data.

16. The method of claim 10, further comprising:
receiving a user request for a distribution report from the user device; and
generating and providing the distribution report to the user interface, wherein the distribution report comprises a graphical summary of the one or more assets associated with each of the beneficiaries.

17. The method of claim 10, wherein the user adjustment comprises selecting an excluding condition associated with one of the beneficiaries; and
wherein the initial distribution data is modeled with the user adjustment to generate the adjusted distribution data by reallocating the one or more assets associated with the one of the beneficiaries to a remainder of the beneficiaries.

18. The method of claim 10, wherein the initial display data further comprises an initial pie chart displaying an initial ratio of an initial value of the one or more assets associated with each of the beneficiaries to a combined value of all of the assets; and
wherein the adjusted display data further comprises an adjusted pie chart displaying an adjusted ratio of an adjusted value of the one or more assets associated with each of the beneficiaries to the combined value of all of the assets.

19. A non-transitory computer-readable storage medium having instructions stored thereon that, when executed by at least one processing circuit, cause the processing circuit to perform operations comprising:
receiving, by a processing circuit, asset data relating to one or more assets of a person and asset distribution parameters;
modeling the asset data with the asset distribution parameters to generate initial distribution data for the assets, wherein the initial distribution data corresponds to one or more initial associations between one or more beneficiaries and the one or more assets based on the asset distribution parameters;
generating initial display data based on the initial distribution data and providing the initial display data to a user interface of a user device, wherein the initial display data comprises a plurality of elements relating to the one or more associations between the one or more assets and the one or more beneficiaries;
receiving a user adjustment to at least one of the elements of the plurality of elements from the user device;
modeling the initial distribution data with the user adjustment to generate adjusted distribution data by adjusting the one or more associations between the one or more beneficiaries and the one or more assets of the initial distribution data based on the user adjustment; and
generating adjusted display data based on the adjusted distribution data and providing the adjusted display data to the user interface.

20. The non-transitory computer-readable storage medium of claim 19, wherein the operations further comprise:
identifying one or more variations between the initial distribution data and the adjusted distribution data;
modeling the one or more variations between the initial distribution data and the adjusted distribution data with the asset distribution parameters to generate suggestion data, wherein the suggestion data corresponds to one or more changes to the asset distribution parameters that would reduce the one or more variations between the initial distribution data and the adjusted distribution data; and
generating suggestion display data of the suggestion data and providing the suggestion display data to the user interface.
